(19) United States
(12) Patent Application Publication
(10) Pub. No.: US 2026/0029860 A1
(43) Pub. Date: Jan. 29, 2026

(54) INFORMATION PROCESSING APPARATUS AND CONTROL METHOD

(71) Applicant: Lenovo (Singapore) Pte. Ltd, Singapore (SG)

(72) Inventors: Yoshinori Ito, Kanagawa (JP); Yuichi Sone, Kanagawa (JP); Poonam Dinesh Panchal, Morrisville, NC (US)

(73) Assignee: Lenovo (Singapore) Pte. Ltd, Singapore (SG)

(21) Appl. No.: 18/785,973

(22) Filed: Jul. 26, 2024

(51) Int. Cl. G06F 3/0346; G06F 1/16; G06F 3/041; G06F 3/04886

(52) U.S. Cl. CPC G06F 3/0346; G06F 1/1652; G06F 3/0412; G06F 3/04886; G06F 2200/1614; G06F 2203/04803

(57) ABSTRACT

An information processing apparatus, that is capable of controlling display by splitting a screen of a display into two or more display areas, includes: a memory configured to store a program of an application; and a processor configured to control displaying a window of the application on the screen of the display by executing the program of the application stored in the memory. The processor is configured to perform display layout control processing of controlling a layout in which arrangement of the display areas is determined when the screen of the display is split into the two or more display areas to a first layout or a second layout depending on display orientation of the screen of the display.

### TECHNICAL FIELD

The present invention relates to an information processing apparatus and a control method.

### BACKGROUND

There is an information processing apparatus that is capable of splitting a display screen into two or more display areas to display a window of an application window or the like in each display area. For example, Japanese Unexamined Patent Application Publication No. 2022-70081 discloses an information processing apparatus in which a flexible display is provided across a first chassis and a second chassis that can be rotated by a hinge mechanism, and when the first chassis and second chassis are in a bent form or a flat form, the screen of the flexible display can be used as one display area or as two split display areas.

In addition, in recent years, some OS functions such as in Windows (registered trademark) enable snap display in which a window of an application is arranged by changing the screen layout to be split into two, three, or four parts.

However, when controlling to change the display orientation according to a change in the orientation of a display, if the screen of the display is used in a layout that is split into two or more display areas, the layout does not respond to a change in the orientation of the display, and the display position of a window in the screen may change. In such a case, the user may have difficulty in tracking the displayed windows with his or her eyes, and may not control the display appropriately.

### SUMMARY

One or more embodiments of the present invention provide an information processing apparatus and a control method that appropriately control display according to a change in the orientation of a display when the screen is split into two or more display areas.

An information processing apparatus according to one or more embodiments of the present invention is an information processing apparatus that is capable of controlling display by splitting a screen of a display into two or more display areas, the apparatus including: a memory configured to store a program of an application, and a processor configured to control displaying a window of the application on the screen of the display by executing the program of the application stored in the memory, in which the processor is configured to perform display layout control processing of controlling a layout in which arrangement of the display areas is determined when the screen of the display is split into the two or more display areas to a first layout or a second layout depending on display orientation of the screen of the display, each of the first layout and the second layout includes two layouts in which the arrangement of the display areas when one layout is rotated 180 degrees around an axis perpendicular to the screen of the display corresponds to the arrangement of the display areas of the other layout, and when rotated 90 degrees around the axis perpendicular to the screen of the display, the two layouts included in the first layout correspond to the arrangement of the display areas of one or the other of the two layouts included in the second layout.

In the information processing apparatus, in the display layout control processing, when the orientation of the screen display of the display is such that a direction of a first axis is an up-down direction of display among the first axis and a second axis that are horizontal to the screen of the display and orthogonal to each other through a center of the screen, the processor may control the layout to the first layout, and when the display orientation of the screen of the display is such that a direction of the second axis is the up-down direction of the display, control the layout to the second layout.

In the information processing apparatus, the display orientation of the screen of the display may be such that a horizontal dimension of the screen is shorter than a vertical dimension of the screen, or the horizontal dimension of the screen is longer than the vertical dimension of the screen.

In the information processing apparatus, when the first layout and the second layout are layouts in which the screen of the display is split into three display areas, the first layout may include a layout in which the screen of the display is split horizontally into a first display area and a second display area along the second axis and the first display area is split into two display areas, and a layout in which the screen of the display is split horizontally into the first display area and the second display area along the second axis and the second display area is split into two display areas, and the second layout may include a layout in which the screen of the display is split horizontally into a third display area and a fourth display area along the first axis and the third display area is split into two display areas, and a layout in which the screen of the display is split horizontally into the third display area and the fourth display area along the first axis and the fourth display area is split into two display areas

In the information processing apparatus, the processor may change the display orientation while maintaining arrangement of the window displayed in each of the two or more display areas in response to a change in orientation of the screen of the display.

In the information processing apparatus, the processor may display an icon from which a display area is selectable, in which the window is to be displayed from among the layouts included in the first layout or the second layout due to accepting the drag operation on the window displayed on the screen of the display, select the display area selected by the drag operation on the icon as a display area for displaying the window being dragged, and display the window in the selected display area in response to completion of the drag operation on the window.

In addition, a control method in an information processing apparatus according to one or more embodiments of the present invention that is capable of controlling display by splitting a screen of a display into two or more display areas, and that includes a memory configured to store a program of an application, and a processor configured to control displaying a window of the application on the screen of the display by executing the program of the application stored in the memory, the control method includes: via the processor, a determination step of determining display orientation of the screen of the display, and a display layout control step of controlling a layout in which arrangement of the display areas is determined when the screen of the display is split into the plurality of display areas to a first layout or a second layout depending on the display orientation of the screen of the display determined in the determination step, in which each of the first layout and the second layout includes two layouts in which the arrangement of the display areas when one layout is rotated 180 degrees around an axis perpendicular to the screen of the display corresponds to the arrangement of the display areas of the other layout, and when rotated 90 degrees around the axis perpendicular to the screen of the display, the two layouts included in the first layout correspond to the arrangement of the display areas of one or the other of the two layouts included in the second layout.

According to one or more embodiments of the present invention, when the screen is split into two or more display areas and used, it is possible to appropriately control according to a change in the orientation of the display.

### BRIEF DESCRIPTION OF THE DRAWINGS

FIG. 1 is a perspective view illustrating the appearance of an information processing apparatus according to one or more embodiments.

FIG. 2 is a side view illustrating an example of the information processing apparatus in a bent form according to one or more embodiments.

FIG. 3 is a side view illustrating an example of the information processing apparatus in a flat form according to one or more embodiments.

FIG. 4 is a view illustrating specific examples of various display modes of the information processing apparatus according to one or more embodiments.

FIGS. 5A-5B are views illustrating a display example of layout selection icons according to one or more embodiments.

FIG. 6 is a view illustrating a first example of display control in a three-part layout according to one or more embodiments.

FIG. 7 is a view illustrating a second example of display control in a three-part layout according to one or more embodiments.

FIG. 8 is a view illustrating an example of display control in a two-part layout according to one or more embodiments.

FIG. 9 is a view illustrating an example of a configuration in which the information processing apparatus according to one or more embodiments is connected to an external display.

FIG. 10 is a view illustrating a display example of display selection icons according to one or more embodiments.

FIG. 11 is a view illustrating a selection example of display selection icons according to one or more embodiments.

FIG. 12 is a view illustrating a list of display modes of the display selection icons according to one or more embodiments.

FIG. 13 is a block view illustrating an example of a hardware configuration of the information processing apparatus according to one or more embodiments.

FIG. 14 is a block view illustrating an example of a functional configuration of the information processing apparatus according to one or more embodiments.

FIG. 15 is a flowchart illustrating an example of display layout control processing when snapping a window according to one or more embodiments.

FIG. 16 is a flowchart illustrating an example of display layout control processing when the orientation of the screen is rotated according to one or more embodiments.

### DETAILED DESCRIPTION

Hereinafter, embodiments of the present invention will be described with reference to the accompanying drawings.

### Appearance of Information Processing Apparatus

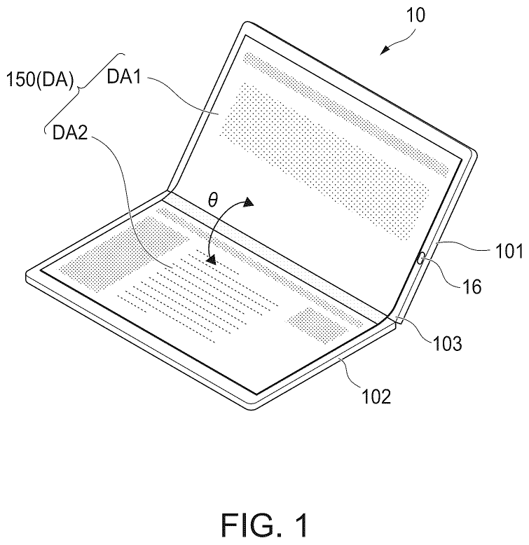

FIG. 1 is a perspective view illustrating the appearance of an information processing apparatus 10 according to one or more embodiments. The information processing apparatus 10 according to one or more embodiments is a clamshell (laptop) personal computer (PC). The information processing apparatus 10 is provided with a first chassis 101, a second chassis 102, and a hinge mechanism 103. The first chassis 101 and the second chassis 102 are chassis having a substantially quadrangular plate shape (for example, flat plate shape). One of side surfaces of the first chassis 101 and one of side surfaces of the second chassis 102 are coupled (connected) via the hinge mechanism 103, and the first chassis 101 and the second chassis 102 are relatively rotatable around a rotation axis formed by the hinge mechanism 103. A state in which an opening angle θ around the rotation axis of the first chassis 101 and the second chassis 102 is about 0° is a state in which the first chassis 101 and the second chassis 102 overlap with each other and are closed. A state in which the first chassis 101 and the second chassis 102 are closed will be referred to as a “closed state”. In the closed state, surfaces of the first chassis 101 and the second chassis 102 facing each other will be referred to as “inner surfaces”, and surfaces opposite to the inner surfaces will be referred to as “outer surfaces”. The opening angle θ can also be referred to as an angle formed by the inner surface of the first chassis 101 and the inner surface of the second chassis 102. A state in which the first chassis 101 and the second chassis 102 are opened with respect to the closed state will be referred to as an “open state”. The open state is a state in which the first chassis 101 and the second chassis 102 are relatively rotated until the opening angle θ exceeds a preset threshold value (for example, 10°).

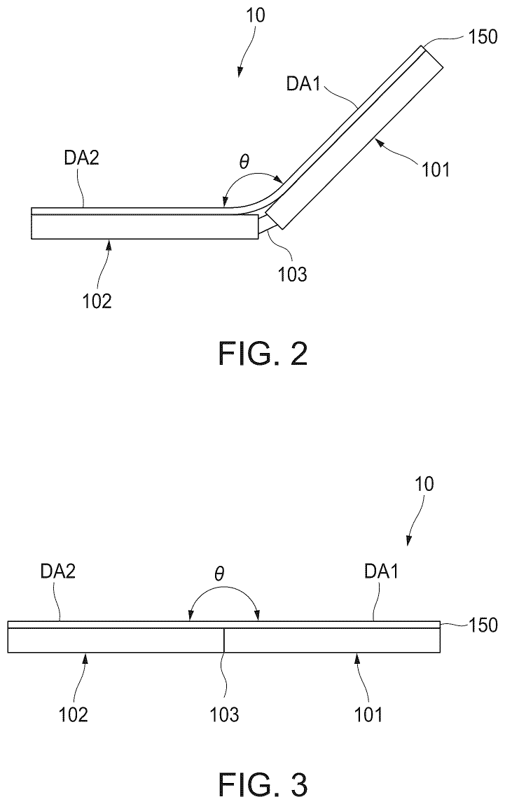

The information processing apparatus 10 is provided with a camera 16 and a display 150. The camera 16 is provided on the inner surface of the first chassis 101. The display 150 is provided over the inner surface of the first chassis 101 and the inner surface of the second chassis 102. The camera 16 is provided in, for example, an outer portion of a screen area of the display 150 on the inner surface of the first chassis 101, and can image a user or the like who exists on the side facing the display 150. The display 150 is a flexible display that can be bent according to the opening angle θ due to the relative rotation of the first chassis 101 and the second chassis 102 (see FIGS. 2 and 3). An organic EL display or the like is used as the flexible display. The information processing apparatus 10 can control display of an entire screen area of the display 150 as one display area DA in a one-screen configuration, and can also control display by splitting the entire screen area of the display 150 into two display areas, a first display area DA1 and a second display area DA2, in a two-screen configuration. Here, the first display area DA1 and the second display area DA2 are the display areas that do not overlap with each other. Here, among the screen areas of the display 150, a display area corresponding to the inner surface side of the first chassis 101 is defined as the first display area DA1, and a display area corresponding to the inner surface side of the second chassis 102 is defined as the second display area DA2. In the following description, a display mode in which display is controlled with the one-screen configuration will be referred to as a “one-screen mode”, and a display mode in which display is controlled with the two-screen configuration will be referred to as a “two-screen mode”.

A touch sensor is provided on the screen area of the display 150. The information processing apparatus 10 can detect a touch operation on the screen area of the display 150. By bringing the information processing apparatus 10 into an open state, the user can visually recognize display of the display 150 provided on the inner surface of each of the first chassis 101 and the second chassis 102, or can perform the touch operation on the display 150, and thus can use the information processing apparatus 10.

Hereinafter, a usage form and the screen mode of the information processing apparatus 10 will be described in detail. First, the usage forms of the information processing apparatus 10 are classified into a bent form in which the first chassis 101 and the second chassis 102 are bent according to the opening angle θ between the first chassis 101 and the second chassis 102, and a flat form in which the first chassis 101 and the second chassis 102 are not bent. In the following description, the bent form in which the first chassis 101 and the second chassis 102 are bent will be simply referred to as a “bent form”, and the flat form in which the first chassis 101 and the second chassis 102 are not bent will be simply referred to as a “flat form”. In the bent form, the display 150 provided over the first chassis 101 and the second chassis 102 is also in the bent form. In the flat form, the display 150 is also in the flat state.

FIG. 2 is a side view illustrating an example of the information processing apparatus 10 in the bent form. The display 150 is arranged over (across) the first chassis 101 and the second chassis 102. The screen area (display area DA illustrated in FIG. 1) of the display 150 can be folded (bent) with a portion corresponding to the hinge mechanism 103 as a crease, and the display area on the first chassis 101 side is illustrated as the first display area DA1 and the display area on the second chassis 102 side is illustrated as the second display area DA2 with the crease as a boundary. The display 150 is bent according to the rotation (opening angle θ) of the first chassis 101 and the second chassis 102. It is determined whether or not the information processing apparatus 10 is in the bent form according to the opening angle θ. As an example, in a case in which 10°<θ<170°, it is determined that the information processing apparatus 10 is in the bent form. This state corresponds to the usage form such as a so-called clamshell mode or book mode.

FIG. 3 is a side view illustrating an example of the information processing apparatus 10 in a flat form. It is typically determined that the information processing apparatus 10 is in the flat form in a case in which the opening angle θ is 180°, but as an example, it may be determined that the information processing apparatus 10 is in the flat form in a case in which 170°≤θ≤180°. For example, in a case in which the opening angle θ between the first chassis 101 and the second chassis 102 is 180°, the display 150 is also in the flat state. This state corresponds to the usage form called a so-called tablet mode.

### Description of Display Mode

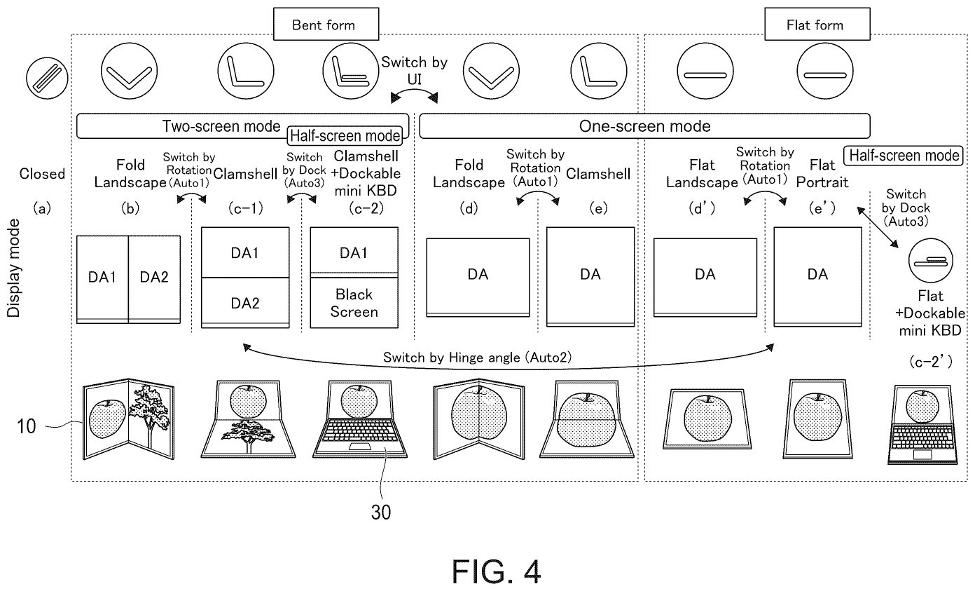

Hereinafter, the display modes according to various usage forms of the information processing apparatus 10 will be described in detail with reference to FIG. 4. FIG. 4 is a view illustrating specific examples of various display modes of the information processing apparatus 10 according to one or more embodiments. The information processing apparatus 10 has different display modes according to the usage forms classified according to the opening angle θ between the first chassis 101 and the second chassis 102, a posture (orientation) of the information processing apparatus 10, whether the one-screen mode is used or the two-screen mode is used, and the like. The one-screen will also be called a single screen, and the two-screen will also be called a split screen, a dual screen, or the like.

A display mode (a) when the first chassis 101 and the second chassis 102 are in the closed state (Closed) as the usage form. In this closed state, the information processing apparatus 10 is, for example, in a standby state such as a sleep or suspended state (hibernation), and the display 150 is in a display-off state. The standby state such as the sleep or suspended state (hibernation) corresponds to S3 or S4 of a power supply state of a system defined by, for example, an advanced configuration and power interface (ACPI).

A display mode (b) is a display mode when the usage form is the bent form, and the two-screen mode is used in which display is controlled such that the screen area of the display 150 is split into the two display areas, the first display area DA1 and the second display area DA2. The orientation of the information processing apparatus 10 is a portrait orientation such that the first display area DA1 and the second display area DA2 are in a portrait orientation and are horizontally arranged from side to side. The portrait orientation of the display area is an orientation in which a long side of four sides of a rectangular display area is in a vertical direction and a short side is in a horizontal direction. In a case in which the display area is in the portrait orientation, a display orientation is also the portrait orientation, and display is performed in an orientation in which a direction along the long side corresponds to an up-down direction and a direction along the short side corresponds to a left-right direction. This usage form is a usage form in which left and right pages when a book is opened correspond to left and right screens, and corresponds to the so-called book mode. This usage form will also be referred to as a “Fold Landscape” because the usage form is the bent form, the first display area DA1 and the second display area DA2 are arranged side by side, and the display area obtained by combining the first display area DA1 and the second display area DA2 is horizontally long.

In this display mode (b), for example, in a normal operation state, the information processing apparatus 10 is in the two-screen display mode in which the first display area DA1 on the left side is used as a primary screen and the second display area DA2 on the right side is used as a secondary screen. In the display mode (b), a correspondence relationship between the first display area DA1 and the second display area DA2, and the primary screen and the secondary screen may be reversed.

As in the display mode (b), a display mode (c-1) is a display mode when the usage form is the bent form, and the two-screen mode is used in which display is controlled such that the screen area of the display 150 is split into two display areas, the first display area DA1 and the second display area DA2, but an orientation of the information processing apparatus 10 is different. The orientation of the information processing apparatus 10 is a portrait orientation such that the first display area DA1 and the second display area DA2 are arranged vertically, up and down in a landscape orientation. The landscape orientation of the display area is an orientation in which a long side of four sides of a rectangular display area is in a horizontal direction and a short side is in a vertical direction. In a case in which the display area is in the landscape orientation, a display orientation is also the landscape orientation, and display is performed in an orientation in which a direction along the short side corresponds to an up-down direction and a direction along the long side corresponds to a left-right direction. This usage form is one of general usage forms of a clamshell PC.

In this display mode (c-1), for example, in a normal operation state, the information processing apparatus 10 is in the two-screen display mode in which the first display area DA1 is used as a primary screen and the second display area DA2 is used as a secondary screen. In the display mode (c-1), a correspondence relationship between the first display area DA1 and the second display area DA2, and the primary screen and the secondary screen may be reversed.

For example, the information processing apparatus 10 detects a change in the posture (orientation) of the information processing apparatus 10, and thus automatically performs switching from the display mode (b) to the display mode (c-1) or from the display mode (c-1) to the display mode (b) (Switch by Rotation). For example, since the display mode (c-1) is a state in which the display 150 is rotated 90 degrees rightward with respect to the display mode (b) as illustrated, when the rightward rotation from a state of the display mode (b) by a predetermined angle (for example, 45 degrees) or more is detected, the information processing apparatus 10 performs the switching to the display mode (c-1). Since the display mode (b) is a state in which the display 150 is rotated 90 degrees leftward with respect to the display mode (c-1) as illustrated, when the leftward rotation from a state of the display mode (c-1) by a predetermined angle (for example, 45 degrees) or more is detected, the information processing apparatus 10 performs the switching to the display mode (b).

As in the display mode (c-1), in a display mode (c-2), the bent form is used and the orientation of the information processing apparatus 10 is the same, but there is a difference in that an external keyboard 30 (Dockable mini Keyboard (KBD)) that can be connected to the information processing apparatus 10 is connected. This usage form is a state in which the physical keyboard 30 is connected in a general usage form of a clamshell PC. For example, the keyboard 30 has almost the same size as the second display area DA2, and can be placed on the second display area DA2. As an example, the keyboard 30 is provided with a magnet in an inner portion (end portion) of a bottom surface, and when the keyboard 30 is placed on the second display area DA2, the keyboard 30 is attracted and fixed to a metal portion of an end portion on the inner surface of the second chassis 102. As a result, the usage form is the same as the usage form of a conventional clamshell PC that is originally provided with the physical keyboard. In addition, the information processing apparatus 10 and the keyboard 30 are connected by, for example, Bluetooth (registered trademark). In this display mode (c-2), the information processing apparatus 10 controls the second display area DA2 to be displayed black or turned off because the second display area DA2 cannot be visually recognized due to the keyboard. In other words, this display mode (c-2) is a display mode (hereinafter, referred to as a “half-screen mode”) in which only half screen is valid for display, and is the one-screen mode using only the first display area DA1.

For example, when the information processing apparatus 10 detects the connection with the external keyboard in a state of the display mode (c-1), the information processing apparatus 10 automatically performs the switching from the display mode (c-1) to the display mode (c-2) (Switch by Dock).

As in the display mode (b), in a display mode (d), the bent form is used and the orientation of the information processing apparatus 10 is the same, but there is a difference in that the display mode (d) is the one-screen mode in which display is controlled such that the entire screen area of the display 150 is used as one display area DA. This usage form is different from the display mode (b) in that the one-screen mode is used, but will also be referred to as the “Fold Landscape” because the bent form is used and the display area DA is horizontally long. The display area DA is in the landscape orientation, and the display orientation is also the landscape orientation.

Here, switching between the one-screen mode and the two-screen mode in the bent form can be performed, for example, by the user's operation. For example, the information processing apparatus 10 displays an operating element as a user interface (UI) that allows switching between the one-screen mode and the two-screen mode at any place on the screen, and performs the switching from the display mode (b) to the display mode (d) based on an operation on the operating element (switch by UI).

As in the display mode (c-1), in a display mode (e), the bent form is used and the orientation of the information processing apparatus 10 is the same, but there is a difference in that the display mode (e) is the one-screen mode in which display is controlled such that the entire screen area of the display 150 is used as one display area DA. This usage form is different from the display mode (c-1) in that the one-screen mode is used, but corresponds to the usage form of the clamshell PC in terms of the bent form and the orientation of the information processing apparatus 10. The display area DA is in the portrait orientation, and the display orientation is also the portrait orientation.

For example, the information processing apparatus 10 detects a change in the posture (orientation) of the information processing apparatus 10, and thus automatically performs switching from the display mode (d) to the display mode (e) or from the display mode (e) to the display mode (d) (Switch by Rotation). For example, since the display mode (e) is a state in which the display 150 is rotated 90 degrees rightward with respect to the display mode (d) as illustrated, when the rightward rotation from a state of the display mode (d) by a predetermined angle (for example, 45 degrees) or more is detected, the information processing apparatus 10 performs the switching to the display mode (e). Since the display mode (d) is a state in which the display 150 is rotated 90 degrees leftward with respect to the display mode (e) as illustrated, when the leftward rotation from a state of the display mode (e) by a predetermined angle (for example, 45 degrees) or more is detected, the information processing apparatus 10 performs the switching to the display mode (d).

As in the display mode (d), in a display mode (d′), the one-screen mode is used and the orientation of the information processing apparatus 10 is an orientation in which the display area DA is horizontally long, but there is a difference in that the flat form is used. The flat form is a state in which the opening angle θ between the first chassis 101 and the second chassis 102 is about 180°. This usage form corresponds to the so-called tablet mode described with reference to FIG. 3, and will also be referred to as the “Flat Landscape” because the flat form is used and the display area DA is horizontally long. This display mode (d′) is different from the display mode (d) only in terms of the opening angle θ between the first chassis 101 and the second chassis 102. As in the display mode (d), the display area DA is in the landscape orientation, and the display orientation is also the landscape orientation.

As in the display mode (e), in a display mode (e′), the one-screen mode is used and the orientation of the information processing apparatus 10 is an orientation in which the display area DA is vertically long, but there is a difference in that the flat form is used. This usage form will also be referred to as a “Flat Portrait” because the flat form is used and the display area DA is vertically long. This display mode (e′) is different from the display mode (e) only in terms of the opening angle θ between the first chassis 101 and the second chassis 102. As in the display mode (e), the display area DA is in the portrait orientation, and the display orientation is also the portrait orientation.

For example, the information processing apparatus 10 detects a change in the posture (orientation) of the information processing apparatus 10, and thus automatically performs switching from the display mode (d′) to the display mode (e′) or from the display mode (e′) to the display mode (d′) (Switch by Rotation). For example, since the display mode (e′) is a state in which the display 150 is rotated 90 degrees rightward with respect to the display mode (d′) as illustrated, when the rightward rotation from a state of the display mode (d′) by a predetermined angle (for example, 45 degrees) or more is detected, the information processing apparatus 10 performs the switching to the display mode (e′). Since the display mode (d′) is a state in which the display 150 is rotated 90 degrees leftward with respect to the display mode (e′) as illustrated, when the leftward rotation from a state of the display mode (e′) by a predetermined angle (for example, 45 degrees) or more is detected, the information processing apparatus 10 performs the switching to the display mode (d′).

Here, switching between the one-screen mode and the two-screen mode in the flat form can be performed, for example, by the user's operation. For example, as described above, in the display mode (d′) and the display mode (e′), the information processing apparatus 10 displays the operating element as a UI that allows switching between the one-screen mode and the two-screen mode at any place on the screen, and by the user operating this operating element, it is also possible to switch to the two-screen mode while remaining in the flat form. For example, when the switching from a state of the display mode (d′) to the two-screen mode is performed, the display state is the same as the display state of the display mode (b) in the flat form. When the switching from a state of the display mode (e′) to the two-screen mode is performed, the display state is the same as the display state of the display mode (c-1) in the flat form.

When the information processing apparatus 10 detects the connection with the keyboard 30 in a state of the display mode (e′), the information processing apparatus 10 automatically performs the switching from the display mode (e′) to the display mode (c-2′) (Switch by Dock). The display mode (c-2′) is the flat form, and is different from the display mode (c-2) only in terms of the opening angle e between the first chassis 101 and the second chassis 102. In this display mode (c-2′), the information processing apparatus 10 controls the second display area DA2 to be displayed black or turned off because the second display area DA2 cannot be visually recognized due to the keyboard. In other words, as in the display mode (c-2), this display mode (c-2′) is the half-screen mode in which only one half screen is valid for display.

Further, the information processing apparatus 10 can also automatically switch from the one-screen mode to the two-screen mode by detecting a change from a flat form to a bent form (switch by hinge angle). For example, in a case in which the change to the bent form in a state of the display mode (d′) is detected based on the opening angle θ between the first chassis 101 and the second chassis 102, the information processing apparatus 10 automatically performs the switching from the display mode (d′) to the display mode (b). In a case in which the change to the bent form in a state of the display mode (e′) is detected based on the opening angle θ between the first chassis 101 and the second chassis 102, the information processing apparatus 10 automatically performs the switching from the display mode (e′) to the display mode (c-1).

Further, the information processing apparatus 10 has a function of arranging a window of an application in a desired display area within the screen area (so-called snap display), in addition to switching between display modes such as the one-screen mode and the two-screen mode described above. For example, the information processing apparatus 10 has a layout in which the arrangement of display areas when splitting the screen of the display 150 into two or more display areas is determined, and displays an operating element as a user interface (UI) from which a display area is selectable, in which a window is to be arranged (layout). Then, the information processing apparatus 10 displays a window in a display area selected by the user based on the user's operation on the operating element. The UI from which the display area in which this window is to be arranged can be selected will be referred to as a “layout selection icon” below.

The layout of the display area that can be selected by operating this layout selection icon is the layout for the entire screen area (display region DA) of the display 150, regardless of whether the display mode described with reference to FIG. 4 is the one-screen mode or the two-screen mode. In addition, in the case of the half-screen mode, since half of the screen area of the display 150 is a valid screen area, the layout is for this half area.

### Example of Layout Selection Icons

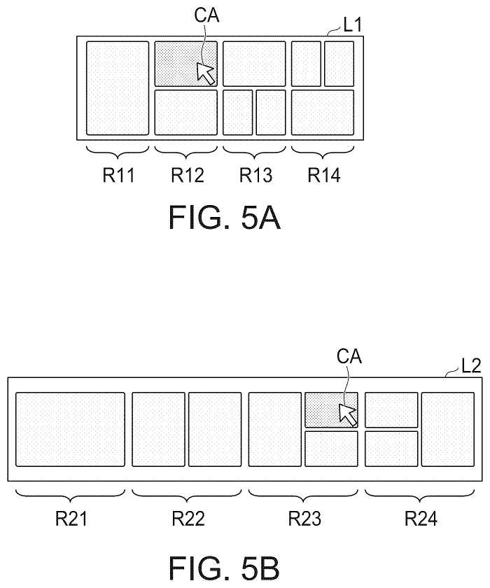

Next, a specific example of the layout selection icons will be described. FIGS. 5A-5B are views illustrating a display example of layout selection icons according to one or more embodiments. The layouts from which a display area is selectable by using the layout selection icons differ depending on the usage form (for example, orientation of the screen of a display) of the information processing apparatus 10. The information processing apparatus 10 controls the layout for “Portrait (or Clamshell)” when the display orientation of the screen of the display 150 is such that the direction of the axis in the long side direction is the up-down direction of the display among “the axis along the long side of the screen” and “the axis along the short side of the screen” that are horizontal to the screen of the display 150 and orthogonal to each other with the center of the screen, and controls the layout for “Landscape” when the display orientation of the screen of the display 150 is such that the direction of the axis in the short side direction is the up-down direction of the display. That is, the selectable layouts differ when the screen area (display area DA) of the display 150 is vertically long, “Portrait (or Clamshell)” (that is, when the display orientation of the screen of the display is such that the horizontal dimension of the screen is shorter than the vertical dimension), and when the screen area (display area DA) of the display 150 is horizontally long, “Landscape” (that is, when the display orientation of the screen of the display is such that the horizontal dimension of the screen is longer than the vertical dimension).

FIG. 5A illustrates an example of a layout selection icon L1 displayed when the usage form is “Portrait (or Clamshell)” (display mode (c-1), display mode (e), display mode (e′), and the like).

In the layout selection icon L1, the portion indicated by a reference numeral R11 is a layout in which the entire screen area of the display 150 is one display area, and the entire screen area can be selected as the display area in which a window is to be arranged. The portion indicated by a reference numeral R12 is a layout in which the screen area is split into two, upper and lower, and the upper display area or the lower display area within the screen area can be selected as the display area in which a window is to be arranged. In addition, the portion indicated by a reference numeral R13 and the portion indicated by a reference numeral R14 are layouts in which the screen area is split into three. The portion indicated by the reference numeral R13 is a layout in which the lower display area, which is obtained by splitting the screen area into two, upper and lower, is further split into two, left and right. The portion indicated by the reference numeral R14 is a layout in which the upper display area, which is obtained by splitting the screen area into two, upper and lower, is further split into two, left and right. In the portion indicated by the reference numeral R13 and the portion indicated by the reference numeral R14, any one of three display areas can be selected as a display area in which a window is to be arranged.

For example, when the usage form is “Portrait (or Clamshell)”, the layout selection icon L1 is displayed when the user drags a window. As illustrated in the figure, when a cursor CA, which is being dragged, is hovered over the upper area of the layout obtained by splitting the screen area into two, indicated by the reference numeral R12, the display area corresponding to the upper area is selected. The display mode (color, brightness, or the like) of the selected area within the layout selection icon L1 is changed. When the drag operation is completed, a window is displayed in the selected upper display area.

FIG. 5B illustrates an example of the layout selection icon L2 displayed when the usage form is “Landscape” (display mode (b), display mode (d), display mode (d′), and the like).

In the layout selection icon L2, the portion indicated by the reference numeral R21 is a layout in which the entire screen area of the display 150 is one display area, and the entire screen area can be selected as the display area in which a window is to be arranged. The portion indicated by a reference numeral R22 is a layout in which the screen area is split into two, left and right, and the left display area or the right display area within the screen area can be selected as the display area in which a window is to be arranged. In addition, the portion indicated by a reference numeral R23 and the portion indicated by a reference numeral R24 are layouts in which the screen area is split into three. The portion indicated by the reference numeral R23 is a layout in which the right display area, which is obtained by splitting the screen area into two, left and right, is further split into two, upper and lower. The portion indicated by the reference numeral R24 is a layout in which the left display area, which is obtained by splitting the screen area into two, left and right, is further split into two, upper and lower. In the portion indicated by the reference numeral R23 and the portion indicated by the reference numeral R24, any one of three display areas can be selected as a display area in which a window is to be arranged.

For example, when the usage form is “Landscape”, the layout selection icon L2 is displayed by the user dragging a window. As illustrated in the figure, when the cursor CA that is being dragged is hovered over the upper area on the right side of the layout in which the screen area indicated by the reference numeral R23 is split into three, the display area corresponding to the upper area on the right side is selected. The display mode (color, brightness, or the like) of the selected area within the layout selection icon L2 is changed. When the drag operation is completed, a window is displayed in the selected upper display area on the right side.

Here, as described above with reference to FIGS. 5A-5B, the layout selection icon L1 and the layout selection icon L2 include a three-part layout in which the screen is split into three display areas. The layout of the layout selection icon L1 for “Portrait (or Clamshell)” includes a layout in which the screen of the display 150 is split horizontally into a first display area and a second display area along an axis in the short side direction of the screen, and the first display area is split into two display areas (for example, the layout indicated by the reference numeral R14 in FIGS. 5A-5B), and a layout in which the screen of the display 150 is split horizontally into the first display area DA1 and the second display area along an axis in the short side direction of the screen, and the second display area is split into two display areas (for example, the layout indicated by the reference numeral R13 in FIGS. 5A-5B). In the three-part layout indicated by the reference numeral R13 of the layout selection icon L1, the arrangement of the display areas when the screen of the display 150 is rotated 180 degrees corresponds to the arrangement of the display areas of the three-part layout indicated by the reference numeral R14.

The layout of the layout selection icon L2 for “Landscape” includes a layout in which the screen of the display 150 is split horizontally into a third display area and a fourth display area along an axis in the long side direction and the third display area is split into two display areas (for example, the layout indicated by the reference numeral R24 in FIGS. 5A-5B), and a layout in which the screen of the display 150 is horizontally split into a third display area and a fourth display area along the axis in the long side direction and the fourth display area is split into two display areas (for example, the layout indicated by the reference numeral R23 in FIGS. 5A-5B). In the three-part layout indicated by the reference numeral R23 of the layout selection icon L2, the arrangement of the display areas when the screen of the display 150 is rotated 180 degrees around an axis perpendicular to the screen corresponds to the arrangement of the display areas in the three-part layout indicated by the reference numeral R24.

In addition, the three-part layout indicated by the reference numeral R13 of the layout selection icon L1 and the three-part layout indicated by the reference numeral R14 correspond to the arrangement of the display areas of the three-part layout indicated by the reference numeral R23 or the three-part layout indicated by the reference numeral R24 of the layout selection icon L2 when the screen of the display 150 is rotated 90 degrees around an axis perpendicular to the screen.

That is, when the orientation of the screen of the display 150 is changed with the three-part layout selected and the usage form is changed from “Portrait (or Clamshell)” to “Landscape” (rotated to the right or left), or even if “Landscape” is changed to “Portrait (or Clamshell)” (rotated to the right or left), a total of four types of layouts are available to maintain the physical display position.

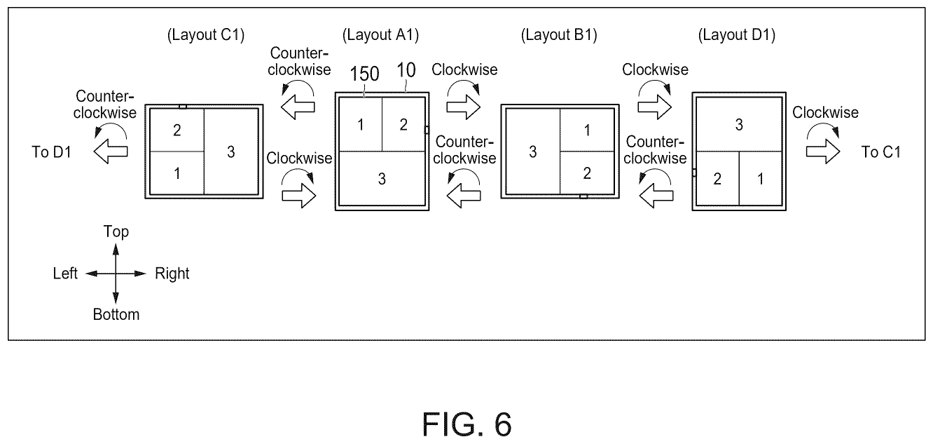

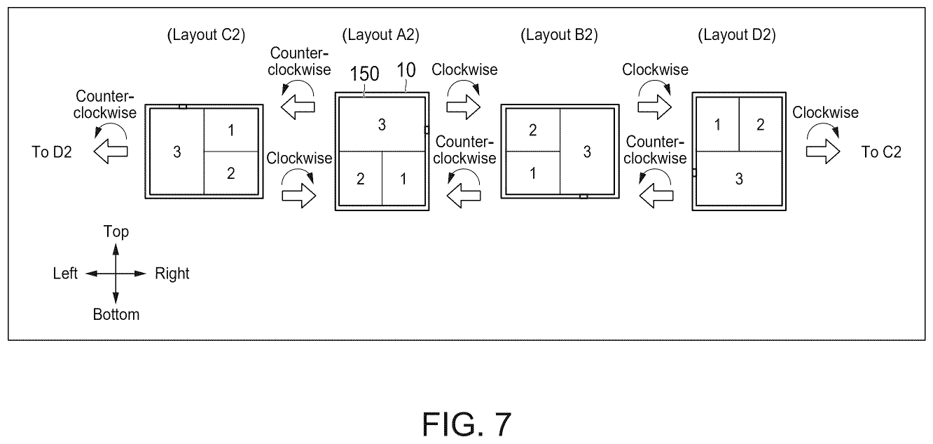

By providing these four types of layouts, when the orientation of the screen of the display 150 is changed (the screen is rotated), display control for changing only the display orientation while maintaining the display position of each display area will be described with reference to FIGS. 6 and 7.

FIG. 6 is a view illustrating a first example of display control in a three-part layout according to one or more embodiments. In this figure, a layout A1 is a state in which the usage form is “Portrait (or Clamshell)” and the layout indicated by the reference numeral R14 of FIGS. 5A-5B is selected. The display control when the orientation of the screen is rotated from this layout A1 is illustrated.

A layout B1 illustrates a state in which the orientation of the screen of the display 150 is rotated to the right (rotated clockwise) from the layout A1, and the usage form is changed to “Landscape” and is changed to the layout indicated by the reference numeral R23 in FIGS. 5A-5B. A layout C1 illustrates a state in which the orientation of the screen of the display 150 is rotated to the left (rotated counterclockwise) from the layout A1, and the usage form is changed to “Landscape” and is changed to the layout indicated by the reference numeral R24 in FIGS. 5A-5B.

A layout D1 illustrates a state in which the orientation of the screen of the display 150 is rotated 180 degrees to the right or left from the layout A1, and the top and bottom of the screen are physically reversed with respect to the layout A1. The layout D1 illustrates a state in which the usage form is “Portrait (or Clamshell)” and the layout indicated by the reference numeral R13 in FIGS. 5A-5B is selected.

“1”, “2”, and “3” illustrated for each display area of each layout in the figure are descriptions to indicate the display content (displayed windows and the like) and display orientation for each display area. The windows displayed in the display areas “1”, “2”, and “3” before the screen is rotated are displayed in the display areas where the same numbers are written after the screen is rotated. The orientation of the numbers “1”, “2”, and “3” indicates the display orientation.

When the orientation of the screen is rotated to the right (rotated clockwise) from the layout A1 (the layout indicated by the reference numeral R14 in FIGS. 5A-5B), the usage form is changed from “Portrait (or Clamshell)” to “Landscape”, which is the layout B1 (the layout indicated by the reference numeral R23 in FIGS. 5A-5B), and the display orientation is changed while maintaining the physical display position of the window displayed in each display area.

In addition, when the orientation of the screen is rotated to the left (rotated counterclockwise) from the layout A1 (the layout indicated by the reference numeral R14 in FIGS. 5A-5B), the usage form is changed from “Portrait (or Clamshell)” to “Landscape”, which is the layout C1 (the layout indicated by the reference numeral R24 in FIGS. 5A-5B), and the display orientation is changed while maintaining the physical display position of the window displayed in each display area.

When the orientation of the screen is rotated to the left (rotated counterclockwise) from the layout B1 (the layout indicated by the reference numeral R23 in FIGS. 5A-5B), and when the orientation of the screen is rotated to the right (rotated clockwise) from the layout C1 (the layout indicated by the reference numeral R24 in FIGS. 5A-5B), the current layout is returned to the layout A1 (the layout indicated by the reference numeral R14 in FIGS. 5A-5B), and the display orientation is similarly changed (returned) while maintaining the physical display position of the window displayed in each display area.

In addition, when the orientation of the screen is rotated to the right (rotated clockwise) from the layout B1 (the layout indicated by the reference numeral R23 in FIGS. 5A-5B), and when the orientation of the screen is rotated to the left (rotated counterclockwise) from the layout C1 (the layout indicated by the reference numeral R24 in FIGS. 5A-5B), the current layout is changed to the layout D1.

As described above, the layout D1 illustrates a state in which the usage form is “Portrait (or Clamshell)” like the layout A1, but illustrates a state in which the top and bottom of the screen are physically reversed with respect to the layout A1, and illustrates a state in which the layout indicated by the reference numeral R13 in FIGS. 5A-5B is selected. When the orientation of the screen is rotated to the right (rotated clockwise) from the layout D1, the usage form is changed to the layout C1, and when the orientation of the screen is rotated to the left (rotated counterclockwise) from the layout D1, the current layout is changed to the layout B1.

FIG. 7 is a view illustrating a second example of display control in a three-part layout according to one or more embodiments. In this figure, the layout A2 is a state in which the usage form is “Portrait (or Clamshell)” and the layout indicated by the reference numeral R13 in FIGS. 5A-5B is selected, and this state illustrates display control when the orientation of the screen is rotated from this layout A2.

The layout B2 show a state in which the orientation of the screen of the display 150 is rotated to the right (rotated clockwise) from the layout A2, the usage form is changed to “Landscape” and is changed to the layout indicated by the reference numeral R24 in FIGS. 5A-5B. A layout C2 illustrates a state in which the orientation of the screen of display 150 is rotated to the left (rotated counterclockwise) from the layout A2, and the usage form is changed to “Landscape” and is changed to the layout indicated by the reference numeral R23 in FIGS. 5A-5B.

A layout D2 illustrates a state in which the orientation of the screen of the display 150 is rotated 180 degrees to the right or left from the layout A2 and the top and bottom of the screen are physically reversed with respect to the layout A2. The layout D2 illustrates a state in which the usage form is “Portrait (or Clamshell)” and the layout indicated by the reference numeral R14 in FIGS. 5A-5B is selected.

Similarly to FIG. 6, “1”, “2”, and “3” illustrated for each display area of each layout in the figure are descriptions to indicate the display content (displayed windows and the like) and display orientation for each display area. Similarly to FIGS. 6 and 7, the windows displayed in the display areas “1”, “2”, and “3” before the screen is rotated are displayed in the display areas where the same numbers are written after the screen is rotated.

When the orientation of the screen is rotated to the right (rotated clockwise) from the layout A2 (the layout indicated by the reference numeral R13 in FIGS. 5A-5B), the usage form is changed from “Portrait (or Clamshell)” to “Landscape”, which is the layout B2 (the layout indicated by the reference numeral R24 in FIGS. 5A-5B), and the display orientation is changed while maintaining the physical display position of the window displayed in each display area.

In addition, when the orientation of the screen is rotated to the left (rotated counterclockwise) from the layout A2 (the layout indicated by the reference numeral R13 in FIGS. 5A-5B), the usage form is changed from “Portrait (or Clamshell)” to “Landscape”, which is the layout C2 (the layout indicated by the reference numeral R23 in FIGS. 5A-5B), and the display orientation is changed while maintaining the physical display position of the window displayed in each display area.

When the orientation of the screen is rotated to the left (rotated counterclockwise) from the layout B2 (the layout indicated by the reference numeral R24 in FIGS. 5A-5B), and when the orientation of the screen is rotated to the right (rotated clockwise) from the layout C2 (the layout indicated by the reference numeral R23 in FIGS. 5A-5B), the current display is returned to the layout A2 (the layout indicated by the reference numeral R13 in FIGS. 5A-5B), and the display orientation is similarly changed (returned) while maintaining the physical display position of the window displayed in each display area.

In addition, when the orientation of the screen is rotated to the right (rotated clockwise) from the layout B2 (the layout indicated by the reference numeral R24 in FIGS. 5A-5B), and when the orientation of the screen is rotated to the left (rotated counterclockwise) from the layout C2 (the layout indicated by the reference numeral R23 in FIGS. 5A-5B), the current layout is changed to the layout D2.

As described above, the layout D2 illustrates a state in which the usage form is “Portrait (or Clamshell)” like the layout A2, but illustrates a state in which the top and bottom of the screen are physically reversed with respect to the layout A2, and illustrates a state in which the layout indicated by the reference numeral R14 in FIGS. 5A-5B is selected. When the orientation of the screen is rotated to the right (rotated clockwise) from the layout D2, the usage form is changed to the layout C2, and when the orientation of the screen is rotated to the left (rotated counterclockwise) from the layout D2, the current layout is changed to the layout B2.

As described above, in the information processing apparatus 10, even if the orientation of the screen of the display 150 changes, the display orientation can be changed while maintaining the physical display positions of the windows displayed in the three-part layout, the user can easily track the displayed windows with his or her eyes and can appropriately control the display.

The display control when a three-part layout is selected by the drag operation on the layout selection icon L1 or the layout selection icon L2 has been described with reference to FIGS. 6 and 7, but the same applies when a two-part layout is selected. Even when the two-part layout is selected, the information processing apparatus 10 changes only the display orientation while maintaining the display position of each display area when rotated to the right or left.

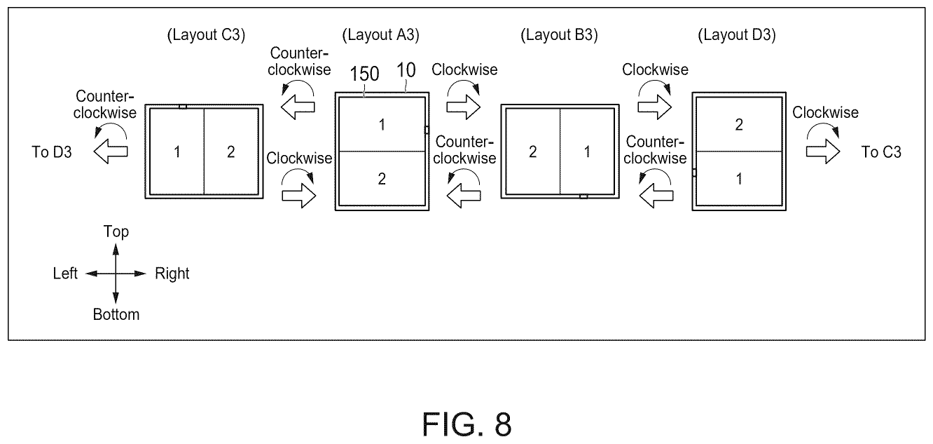

FIG. 8 is a view illustrating an example of display control in a two-part layout according to one or more embodiments. In this figure, the layout A3 is a state in which the usage form is “Portrait (or Clamshell)” and the layout indicated by the reference numeral R12 in FIGS. 5A-5B is selected, and this state illustrates display control when the orientation of the screen is rotated from this layout A3.

Similarly to FIGS. 6 and 7, “1” and “2” illustrated for each display area of each layout in the figure are descriptions to indicate the display content (displayed windows and the like) and display orientation for each display area. The windows displayed in the display areas “1” and “2” before the screen is rotated are displayed in the display areas where the same numbers are written after the screen is rotated.

When the orientation of the screen is rotated to the right (rotated clockwise) from the layout A3 (the layout indicated by the reference numeral R12 in FIGS. 5A-5B), the usage form is changed from “Portrait (or Clamshell)” to “Landscape”, which is the layout B3 (the layout indicated by the reference numeral R22 in FIGS. 5A-5B), and the display orientation is changed while maintaining the physical display position of the window displayed in each display area. That is, when the window displayed in the upper display area “1” in the layout A3 is rotated to the right (rotated clockwise), the window is displayed in the display area “1” on the right side of the layout B3 with the display position maintained, and the display orientation is changed to be the orientation of “1”. Similarly, the window displayed in the lower display area “2” in the layout A3 is rotated to the right (rotated clockwise), the window is displayed in the display area “2” on the left side of the layout B3 with the display position maintained, and the display orientation is changed to be the orientation of “2”.

In addition, when the orientation of the screen is rotated to the left (rotated counterclockwise) from the layout A3 (the layout indicated by the reference numeral R12 in FIGS. 5A-5B), the usage form is changed from “Portrait (or Clamshell)” to “Landscape”, which is the layout C3 (the layout indicated by the reference numeral R22 in FIGS. 5A-5B), and the display orientation is changed while maintaining the physical display position of the window displayed in each display area. That is, when the window displayed in the upper display area “1” in the layout A3 is rotated to the left (rotated counterclockwise), the window is displayed in the display area “1” on the left side of the layout C3 while maintaining the display position of the window, and the display orientation is changed to be the orientation of “1”. Similarly, the window displayed in the lower display area “2” in the layout A3 is rotated to the left (rotated counterclockwise), the window is displayed in the display area “2” on the right side of the layout B3 with the display position maintained, and the display orientation is changed to be the orientation of “2”.

In addition, when the orientation of the screen is rotated to the right (rotated clockwise) from the layout B3, and when the orientation of the screen is rotated to the left (rotated counterclockwise) from the layout C3, the current layout is changed to the layout D3.

The layout D3 illustrates a state in which the usage form is “Portrait (or Clamshell)” like the layout A3 and the layout indicated by the reference numeral R12 in FIGS. 5A-5B is selected, but illustrates a state in which the top and bottom of the screen are physically reversed with respect to the layout A3.

When the orientation of the screen is rotated to the right (rotated clockwise) from the layout D3, the current layout is changed to the layout C3. That is, when the window displayed in the upper display area “2” in the layout D3 is rotated to the right (rotated clockwise), the window is displayed in the display area “2” on the right side of the layout C3 with the display position maintained, and the display orientation is changed to be the orientation of “2”. Similarly, the window displayed in the lower display area “1” in the layout D3 is rotated to the right (rotated clockwise), the window is displayed in the display area “1” on the left side of the layout C3 with the display position maintained, and the display orientation is changed to be the orientation of “1”.

In addition, when the orientation of the screen is rotated to the left (rotated counterclockwise) from the layout D3, the current layout is changed to the layout B3. That is, when the window displayed in the upper display area “2” in the layout D3 is rotated to the left (rotated counterclockwise), the window is displayed in the display area “2” on the left side of the layout B3 while maintaining the display position of the window, and the display orientation is changed to be the orientation of “2”. Similarly, the window displayed in the lower display area “1” in the layout D3 is rotated to the left (rotated counterclockwise), the window is displayed in the display area “1” on the right side of the layout B3 with the display position maintained, and the display orientation is changed to be the orientation of “1”.

Each of the layouts D1, D2, and D3 illustrates a state in which the top and bottom of the screen are physically reversed with respect to each of the layouts A1, A2, and A3. Therefore, when the usage form of the layouts A1, A2, and A3 is referred to as “Portrait,” the usage form of the layouts D1, D2, and D3 is sometimes called “Flipped Portrait.” In addition, since the relationship between each of the layouts B1, B2, and B3 and each of the layouts C1, C2, and C3 is such that the left and right of one screen are physically reversed with respect to the other screen, when one type of usage form is referred to as “Landscape”, the other type of usage form may be referred to as “Flipped Landscape”.

### Configuration of Connection with External Display

In addition, the information processing apparatus 10 can also be used by being connected to an external display. In the case of an external display whose screen can be rotated, the display control according to the screen rotation described above with reference to FIGS. 5A to 7 can be applied.

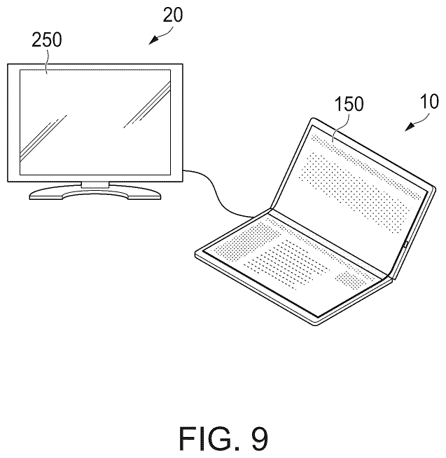

FIG. 9 is a view illustrating an example of a configuration in which the information processing apparatus 10 according to one or more embodiments is connected to an external display. The information processing apparatus 10 is connected to an external display device 20 (display device). Any connection method using HDMI (registered trademark), USB Type-C, display port, or the like can be applied as a connection method. The information processing apparatus 10 may be wirelessly connected to the external display device 20. The external display device 20 is configured to include a display 250 as an external display. In contrast to an external display, the display 150 of the information processing apparatus 10 is an embedded display.

When connecting to the external display device 20 and controlling display in a plurality of screen areas (a plurality of screen areas that do not overlap with each other) between the screen area of the embedded display and the screen area of the external display, the information processing apparatus 10 can display a window on both the screen area of the embedded display and the screen area of the external display by using the layout selection icons described with reference to FIGS. 5A-5B.

For example, the information processing apparatus 10 can display a window displayed in the screen area of the embedded display in any of the display areas in each layout within the screen area of the embedded display, or can display the window in any of the display areas in each layout of the external display. Similarly, the information processing apparatus 10 can display a window displayed on the screen area of the external display in any of the display areas in each layout of the external display, or in any of the display areas in each layout within the screen area of the embedded display.

When connected to the external display device 20, the information processing apparatus 10 displays a UI as an operating element for selecting which of the embedded display and the external display is to be the screen area for displaying a window before displaying the layout selection icons illustrated in FIGS. 5A-5B. This UI will be referred to as a “display selection icon” below.

### Example of Display Selection Icons

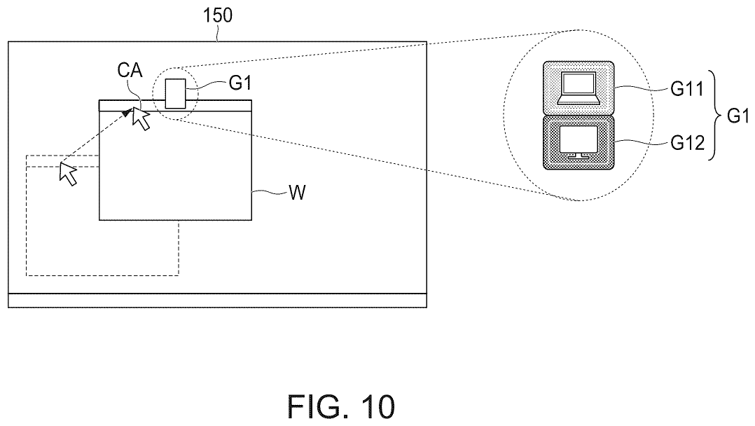

FIG. 10 is a view illustrating a display example of display selection icons according to one or more embodiments. When a drag operation is started on a window W displayed on the embedded display (display 150) or external display (display 250), display selection icons G1 are displayed near the position of the cursor CA to be dragged. This figure illustrates an example when a drag operation is started on the window W displayed on the embedded display (display 150). The display position of the display selection icons G1 remains unchanged even if the cursor CA is moved by a drag operation.

The display selection icons G1 include an embedded display icon G11 corresponding to the screen area of the embedded display, and an external display icon G12 corresponding to the screen area of the external display. The embedded display icon G11 and the external display icon G12 are displayed with different designs (figures, pictures) imitating the types of the respective displays. That is, the embedded display icon G11 has a design imitating the embedded display provided in the information processing apparatus 10 (for example, a notebook PC). On the other hand, the external display icon G12 has a design imitating the shape of the external display device 20. As a result, when selecting a display for displaying (screen area) by using the display selection icon G1, it is intuitive to know which icon is the selection for the embedded display and which icon is the selection for the external display, and the operability is good.

In addition, the display mode (for example, icon color (background color)) of the embedded display icon G11 and the external display icon G12 differs depending on whether or not the icon corresponds to the screen area in which a drag operation is started. For example, in the illustrated example, the background color of the embedded display icon G11 corresponding to the screen area where a drag operation is started is blue, but the background color of the external display icon G12 other than the screen area where the drag operation is started is gray.

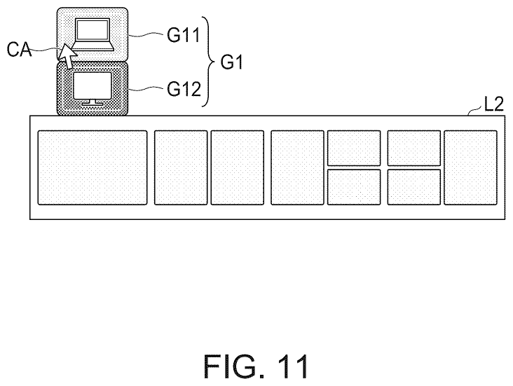

FIG. 11 is a view illustrating a selection example of display selection icons according to one or more embodiments. By hovering the cursor CA that is being dragged over either the embedded display icon G11 or the external display icon G12 of the display selection icon G1, it is possible to select the screen area of the embedded display or the screen area of the external display.

As illustrated in the figure, when the cursor CA that is being dragged is hovered over the embedded display icon G11, the screen area of the embedded display is selected. In addition, when the screen area of the embedded display is selected, a layout selection icon is displayed, from which a display area in each layout within the screen area of the embedded display can be selected. The layout selection icon L1 or the layout selection icon L2 is displayed depending on whether the usage form at that time is “Portrait (or Clamshell)” or “Landscape”. Here, the layout selection icon L2 displayed when “Landscape” is selected is illustrated as an example. By selecting the display area of one of the layouts of this layout selection icon L2 as illustrated in FIGS. 5A-5B, the window that is being dragged is displayed in the display area of the selected layout.

As for the layout selection icon displayed when the external display icon G12 is hovered, if the aspect ratio of the screen of the external display is vertically long, the layout selection icon L1 is displayed, and if the aspect ratio of the screen of the external display is horizontally long, the layout selection icon L2 is displayed. In the case of an external display equipped with a rotation function, if the aspect ratio of the screen changes due to rotation, the displayed layout selection icon will also change.

Also, even if there is no external display connected and only the embedded display, when a drag operation is performed on a window of an application, the display selection icons G1 that include only the embedded display icon G11 among the embedded display icon G11 and the external display icon G12 illustrated in FIG. 10 may be displayed. When a drag operation is started, if the layout selection icon L1 or the layout selection icon L2 is directly displayed without displaying the display selection icon G1, a relatively wide area within the screen area will be occupied, but since the user may simply want to move a window, the smaller the initial occupied area is, the more likely it is to avoid erroneous operations (unintentional snaps).

In addition, the display modes of the embedded display icon G11 and the external display icon G12 included in the display selection icons G1 differ depending on whether or not the display (screen area) on which a drag operation has been started is selected.

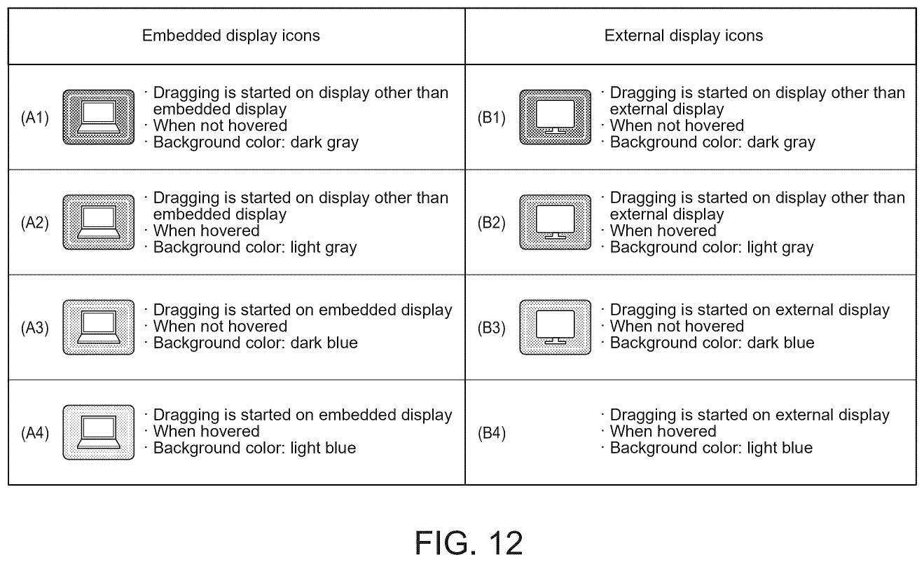

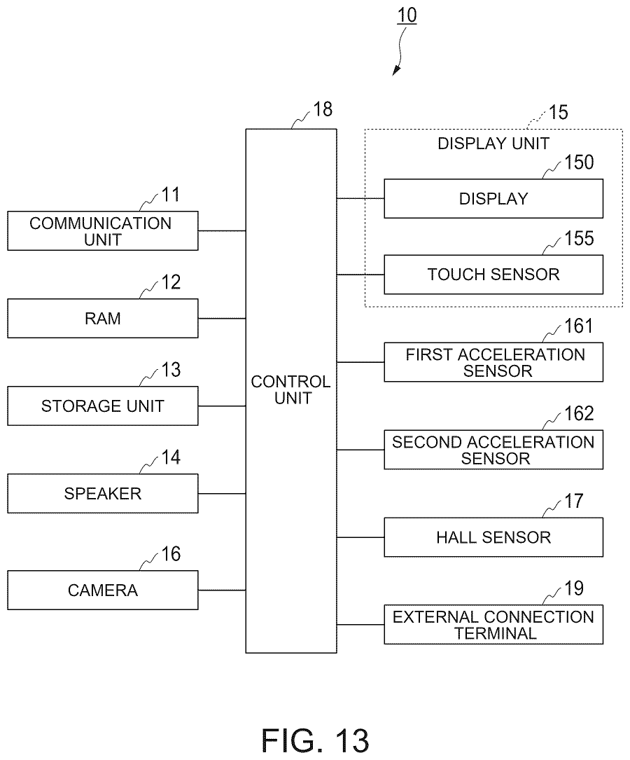

Here, the types of display modes of the display selection icons G1 that are changed according to conditions will be described with reference to FIG. 12.

FIG. 12 is a view illustrating a list of display modes of display selection icons according to one or more embodiments.

(A1) to (A4) illustrate examples of the display mode of the embedded display icon G11, and (B1) to (B4) illustrate examples of the display mode of the external display icon G12. As described above, the embedded display icon G11 and the external display icon G12 have different designs (figures, pictures) imitating the types of the respective displays.

Further, the embedded display icon G11 changes into four types of display modes (A1), (A2), (A3), and (A4) depending on whether or not the display (screen area) on which the drag operation has been started is selected. Here, the state in which the embedded display icon G11 is selected is, for example, a state in which the cursor CA that is being dragged is hovered over the embedded display icon G11, as described with reference to FIG. 11. In a state in which the cursor CA that is being dragged is not hovered over the embedded display icon G11, the embedded display icon G11 is in an unselected state.

(A1) illustrates an example of the display mode when a drag operation is started on a display other than the embedded display (here, the external display) and the embedded display icon is not hovered, and for example, the background color is dark gray. (A2) illustrates an example of the display mode when a drag operation is started on a display other than the embedded display (here, the external display) and the embedded display icon is hovered, and for example, the background color is light gray.

(A3) illustrates an example of the display mode when a drag operation is started on the embedded display and the embedded display icon is not hovered, and for example, the background color is dark blue. (A4) illustrates an example of the display mode when a drag operation is started on the embedded display and the embedded display icon is hovered, and for example, the background color is light blue.

Similarly, the external display icon G12 changes into four types of display modes (B1), (B2), (B3), and (B4) depending on whether or not the display (screen area) on which a drag operation is started is selected. Here, the state in which the external display icon G12 is selected is, for example, a state in which the cursor CA that is being dragged is hovered over the external display icon G12. In a state in which the cursor CA that is being dragged is not hovered over the external display icon G12, the external display icon G12 is in an unselected state.

(B1) illustrates an example of the display mode when a drag operation is started on a display other than the external display (here, the embedded display) and the external display icon is not hovered, and for example, the background color is dark gray. (B2) illustrates an example of the display mode when a drag operation is started on a display other than the external display (here, the embedded display) and the external display icon is hovered, and for example, the background color is light gray.

(B3) illustrates an example of the display mode when a drag operation is started on the external display and the external display icon is not hovered, and for example, the background color is dark blue. (B4) illustrates an example of the display mode when a drag operation is started on the external display and the external display icon is hovered, and for example, the background color is light blue.

As described above, when selecting a display for displaying a window between the embedded display and external display, since the designs (figures, pictures) of the embedded display icon G11 and the external display icon G12 to be selected are different, and the display mode (for example, background color) of the icon on the display on which a drag operation is started is different from the display mode of the icon on the other display, it is easy to intuitively recognize which display each icon corresponds to, and operability is good.

### Configuration of Information Processing Apparatus

Hereinafter, a specific configuration of the information processing apparatus 10 will be described.

FIG. 10 is a block view illustrating an example of a hardware configuration of the information processing apparatus 10 according to one or more embodiments. The information processing apparatus 10 includes a communication unit 11, a random access memory (RAM) 12, a storage unit 13, a speaker 14, a display unit 15, a camera 16, a first acceleration sensor 161, and a second acceleration sensor 162, a hall sensor 17, a control unit 18, and an external connection terminal 19. These units are communicably connected to each other via a bus or the like.

The communication unit 11 includes, for example, digital input/output ports such as a plurality of Ethernet (registered trademark) ports or a plurality of universal serial buses (USB), and a communication device that performs wireless communication such as Bluetooth (registered trademark) or Wi-Fi (registered trademark). For example, the communication unit 11 can communicate with the external keyboard 30 or the like described above by using Bluetooth (registered trademark).

A program or data for the process executed by the control unit 18 is loaded in the RAM 12, and various types of data are saved or deleted as appropriate. For example, the RAM 12 also functions as a display video memory (V-RAM) for display of the display 150. As an example, the RAM 12 functions as a video memory for data displayed in each display area within the screen area of the display 150 (or the display 250 when the external display device 20 is connected). In addition, the RAM 12 stores information about running apps, which apps are being used among running apps (apps in active windows), information about other apps in inactive windows, information such as in which display area each window is displayed, in which layer each window is arranged, the size of the window, and whether or not the window is minimized. Since the RAM 12 is a volatile memory, the data is not held when the supply of power to the RAM 12 is stopped. The data that needs to be held when the supply of power to the RAM 12 is stopped is transferred to the storage unit 13.

The storage unit 13 includes any one or more of a solid state drive (SSD), a hard disk drive (HDD), a read only memory (ROM), a Flash-ROM, and the like. For example, the storage unit 13 saves a program or setting data of a basic input output system (BIOS), a program of an operating system (OS) or an app operating on the OS, various types of data used in the app, and the like. The speaker 14 outputs an electronic sound, a voice, or the like.

The display unit 15 is provided with the display 150 and a touch sensor 155. As described above, the display 150 is a flexible display that can be bent according to the opening angle θ due to the relative rotation of the first chassis 101 and the second chassis 102. The display 150 performs display corresponding to each display mode described with reference to FIG. 4 according to the control of the control unit 18. The touch sensor 155 is provided on the screen of the display 150, and detects the touch operation on the screen. For example, the touch sensor 155 detects the touch operation on the display area DA in the one-screen mode. In addition, the touch sensor 155 detects the touch operation on one or both of the first display area DA1 and the second display area DA2 in the two-screen mode. A tap operation, a slide operation, a flick operation, a swipe operation, a pinch operation, and the like are included in the touch operation. The touch sensor 155 detects the touch operation to output operation information based on the detected operation to the control unit 18.

The camera 16 includes a lens, an imaging element, and the like. The camera 16 captures an image (a still image or a moving image) according to the control of the control unit 18 to output data of the captured image.

The first acceleration sensor 161 is provided inside the first chassis 101, and detects the orientation of the first chassis 101 and the change in the orientation. For example, assuming that a direction parallel to a longitudinal direction of the first display area DA1 is an X1 direction, a direction parallel to a lateral direction is a Y1 direction, and a direction perpendicular to the X1 direction and the Y1 direction is a Z1 direction, the first acceleration sensor 161 detects acceleration in each of the X1 direction, the Y1 direction, and the Z1 direction to output the detection result to the control unit 18.

The second acceleration sensor 162 is provided inside the second chassis 102, and detects the orientation of the second chassis 102 and the change in the orientation. For example, assuming that a direction parallel to a longitudinal direction of the second display area DA2 is an X2 direction, a direction parallel to a lateral direction is a Y2 direction, and a direction perpendicular to the X2 direction and the Y2 direction is a Z2 direction, the second acceleration sensor 162 detects acceleration in each of the X2 direction, the Y2 direction, and the Z2 direction to output the detection result to the control unit 18.

The hall sensor 17 is provided to detect the connection with the keyboard 30. For example, when the keyboard 30 is placed on the second display area DA2 of the second chassis 102, a magnetic field is changed due to approaching of the magnet provided in the inner portion of the bottom surface of the keyboard 30, and the detection value (output value) of the hall sensor 17 is changed. In other words, the hall sensor 17 outputs different detection results according to whether or not the keyboard 30 is placed. Here, the hall sensor 17 is used to detect whether or not the keyboard 30 is placed, but the detection method is not limited thereto, and any detection method can be used.

The external connection terminal 19 is a connection terminal for connecting to the external display device 20 (external display). For example, the external connection terminal 19 is an HDMI (registered trademark) terminal, a USB Type-C terminal, a display port, or the like. The information processing apparatus 10 and the external display device 20 may be connected wirelessly.

The control unit 18 includes a processor such as a central processing unit (CPU), a graphic processing unit (GPU), or a microcomputer, and realizes various functions by the processor executing the programs (various programs such as the BIOS, the OS, and the app operating on the OS) stored in the storage unit 13 or the like. For example, the control unit 18 detects the posture (orientation) of the information processing apparatus 10 based on the detection results of the first acceleration sensor 161 and the second acceleration sensor 162. In addition, the control unit 18 detects, based on the detection results of the first acceleration sensor 161 and the second acceleration sensor 162, whether the information processing apparatus 10 is in the open state or closed state, and whether the information processing apparatus 10 is in the bent form or the flat form in the open state, or the like.

In addition, the control unit 18 detects the connection with the keyboard 30 based on the detection result of the hall sensor 17. The connection with the keyboard 30 refers to the placement of the keyboard 30 on the second display area DA2, and does not refer to communication connection. The control unit 18 detects the communication connection with the keyboard 30 by using a function of Bluetooth (registered trademark) or the like.

In addition, the control unit 18 controls the display of the display 150 described with reference to FIG. 4 by detecting the state of the system, the posture (orientation) of the information processing apparatus 10, whether the information processing apparatus 10 is in the open or closed state, whether the information processing apparatus 10 is in the bent form or flat form in the open state, whether the information processing apparatus 10 is connected to the keyboard 30, and the like.

Further, by dragging a window displayed on the display 150 (embedded display) or the display 250 (external display), the control unit 18 displays a display selection icon or a layout selection icon for selecting the display destination and screen layout of the window (see FIGS. 5A-5B and FIGS. 10 to 12). In addition, the control unit 18 performs display control according to the rotation of the screen of the display 150 (see FIGS. 6 to 8).

Next, according to the user's operation on the display selection icons and layout selection icons and the rotation of the screen in the processing executed by the control unit 18, display layout control processing of controlling the display destination and layout of a window will be described in detail.

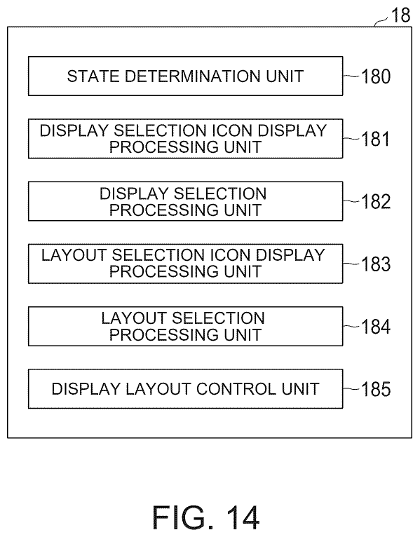

FIG. 14 is a block view illustrating an example of a functional configuration related to the display layout control processing of the information processing apparatus 10 according to one or more embodiments. As a functional configuration in which the CPU executes processing based on the OS, programs running on the OS, or the like, the control unit 18 includes, a state determination unit 180, a display selection icon display processing unit 181, a display selection processing unit 182, a layout selection icon display processing unit 183, a layout selection processing unit 184, and a display layout control unit 185.

The state determination unit 180 determines whether the posture (orientation) of the information processing apparatus 10 in an open state or closed state, whether the posture is in a bent form or in a flat form in the open state, whether the keyboard 30 is connected or not, the rotation of the screen, or the like.

For example, based on the detection results of the first acceleration sensor 161 and the second acceleration sensor 162, the state determination unit 180 detects whether the information processing apparatus 10 is in an open state or a closed state, and detects the opening angle θ in the closed state to detect and determine whether the information processing apparatus 10 is in a bent form or flat form. In addition, the state determination unit 180 determines whether the keyboard 30 is detected or not by detecting whether the keyboard 30 is placed on the second display area DA2 based on the detection result of the hall sensor 17.

In addition, the state determination unit 180 detects and determines the posture (orientation) of the information processing apparatus 10 based on the detection results of the first acceleration sensor 161 and the second acceleration sensor 162. For example, the state determination unit 180 determines whether the display orientation (usage form) of the screen of the display 150 is “Portrait (or Clamshell)” or “Landscape” as the posture (orientation) of the information processing apparatus 10. In addition, the state determination unit 180 detects and determines whether or not the display 150 has been rotated by a predetermined angle (for example, 45 degrees) or more in the right direction (clockwise) or left direction (counterclockwise) about an axis perpendicular to the screen of the display 150. When determining the rotation of the screen of the external display (display 250), the state determination unit 180 obtains information corresponding to the rotation angle of the screen from the external display device 20.

The display selection icon display processing unit 181 performs the display process of display selection icons. For example, in a state of being connected to an external display, when a drag operation is accepted for a window displayed on at least one of the screen area of the embedded display and the screen area of the external display, the display selection icon display processing unit 181 displays the display selection icons G1 in the screen area in which a drag operation is started (see FIG. 10). The display selection icons G1 include an embedded display icon G11 corresponding to the screen area of the embedded display, and an external display icon G12 corresponding to the screen area of the external display.

For example, the display selection icon display processing unit 181 displays the embedded display icon G11 and the external display icon G12 in different designs imitating the types of the respective displays (see FIGS. 10 to 12).

In addition, the display selection icon display processing unit 181 makes the display modes of the icon corresponding to the screen area in which a drag operation is started between the embedded display icon G11 and the external display icon G12 and the other icon different from each other. For example, the display selection icon display processing unit 181 makes the colors (for example, background color) of the icon corresponding to the screen area in which a drag operation is started between the embedded display icon G11 and the external display icon G12 and the other icon different from each other (see FIGS. 10 to 12).

In addition, the display selection icon display processing unit 181 makes the display modes different from each other when the embedded display icon G11 is selected by a drag operation and when the embedded display icon G11 is not selected, and when the external display icon G12 is selected by a drag operation and when the external display icon G12 is not selected (see FIG. 12).

In a state of not being connected to an external display, the display selection icon G1 does not include the external display icon G12, but only the embedded display icon G11.

The display selection processing unit 182 selects the screen area corresponding to the icon selected by a drag operation between the embedded display icon G11 and the external display icon G12 as a screen area in which a window being dragged is to be displayed. In a state of being connected to an external display, only the embedded display icon G11 can be selected.

The layout selection icon display processing unit 183 newly displays a layout selection icon from which a display area in which a window is to be displayed can be selected within the screen area selected by the display selection processing unit 182 (see FIG. 11). For example, based on the determination result of the state determination unit 180, the layout selection icon display processing unit 183 displays the layout selection icon L1 illustrated in FIG. 5A when the usage form is “Portrait (or Clamshell)”, and displays the layout selection icon L2 illustrated in FIG. 5B when the usage form is “Landscape”.

The layout selection processing unit 184 selects the display area selected by the drag operation on the layout selection icon as a display area in which a window being dragged is to be displayed.

The display layout control unit 185 controls a layout in which arrangement of display areas is determined when the screen of the embedded display or the external display is split into the two or more display areas to “Portrait (or Clamshell)” (an example of the first layout) or a layout for “Landscape” (an example of the second layout) depending on the display orientation of the screen of the display.

In addition, as described with reference to FIGS. 6 to 8, based on the determination result of the state determination unit 180, whether the orientation of the screen is rotated to the right (rotated clockwise) or to the left (rotated counterclockwise), the display layout control unit 185 changes the display orientation depending on the orientation of the screen of the display while maintaining the display position (arrangement) of the window displayed in each of the two or more display areas in each layout.

In response to the completion of a drag operation on a window, the display layout control unit 185 changes the display position of the window to the display area selected by the layout selection processing unit 184 within the screen area of the display selected by the display selection processing unit 182.

### Operation of Display Layout Control Processing

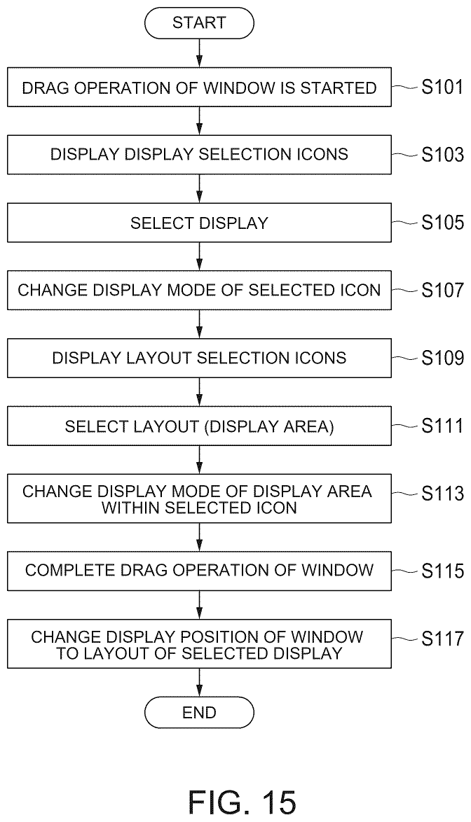

Next, an operation of display layout control processing executed by the control unit 18 will be described. First, with reference to FIG. 15, an operation of display layout control processing of changing (snapping) the display position of a window based on the user's operation on the display selection icons and layout selection icons will be described. Here, the information processing apparatus 10 is described as being connected to the external display device 20 and controlling the display of the embedded display and the external display. FIG. 15 is a flowchart illustrating an example of display layout control processing when snapping a window according to one or more embodiments.

(Step S101) When the control unit 18 accepts that a drag operation has been started on the window displayed on the screen area of the embedded display or the external display, the process advances to step S103.

(Step S103) the control unit 18 displays the display selection icons G1 on the screen area of the display on which the drag operation is started, between the embedded display and the external display (see FIG. 10). For example, the control unit 18 displays the embedded display icon G11 and the external display icon G12 included in the display selection icons G1 with different designs (figures, pictures) imitating the types of the respective displays (see FIG. 10). Then, the process advances to step S105.

(Step S105) The control unit 18 selects the screen area corresponding to the icon selected by a drag operation between the embedded display icon G11 and the external display icon G12 as the screen area of a display for displaying the window being dragged (see FIG. 8). Then, the process advances to step S107.

(Step S107) The control unit 18 changes the display mode of the icon selected in step S105. For example, the control unit 18 changes the background color of the icon selected between the embedded display icon G11 and the external display icon G12 from dark blue to light blue, or from dark gray to light gray (see FIG. 12). Then, the process advances to step S109.

(Step S109) The control unit 18 newly displays a layout selection icon from which a display area can be selected, in which a window is to be displayed within the screen area of the display selected in step S105 (see FIG. 11). For example, the control unit 18 displays the layout selection icon L1 illustrated in FIG. 5A when the usage form is “Portrait (or Clamshell)”, and displays the layout selection icon L2 illustrated in FIG. 5B when the usage form is “Landscape”. Then, the process advances to step S111.

(Step S111) The control unit 18 selects the display area selected by the drag operation on the layout selection icon as a display area for displaying the window being dragged. Then, the process advances to step S113.

(Step S113) The control unit 18 changes the display mode (color, brightness, or the like) of the display area within the layout selection icon selected in step S111. Then, the process advances to step S115.

(Step S115) when the control unit 18 accepts that a drag operation has been completed on the window, the process advances to step S117.

(Step S117) The control unit 18 changes the display position of the window to a display area within the screen area of the selected display.

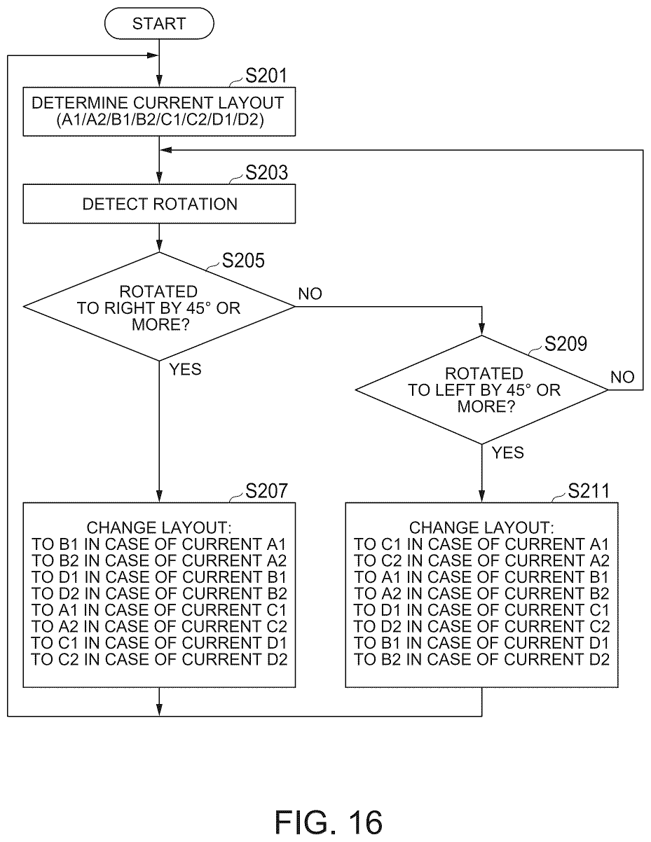

Next, with reference to FIG. 16, the operation of display layout control processing of changing the layout depending on the orientation of the screen of a display will be described. The display to be subjected to this processing may be an embedded display or an external display, and the processing is similar for either display. FIG. 16 is a flowchart illustrating an example of display layout control processing when the orientation of the screen is rotated according to one or more embodiments. Here, description will be given by using examples illustrated in FIGS. 6 and 7.

(Step S201) The control unit 18 determines which of the layout A1, layout A2, layout B1, layout B2, layout C1, layout C2, layout D1, and layout D2 illustrated in FIGS. 6 and 7 is the current layout. Then, the process advances to step S203.

(Step S203) The control unit 18 detects the rotation of the screen of the display 150 based on the detection results of the first acceleration sensor 161 and the second acceleration sensor 162. In addition, when detecting the rotation of the screen of the external display (display 250), the control unit 18 uses information obtained from the external display device 20 to detect the rotation. Then, the process advances to step S205.

(Step S205) The control unit 18 determines whether the display screen has been rotated to the right (clockwise) by a predetermined threshold value (for example, 45 degrees) or more. When the control unit 18 determines that the display screen has been rotated to the right by the predetermined threshold value (for example, 45 degrees) or more (YES), the process advances to step S207. On the other hand, when the control unit 18 determines that the display screen has not been rotated to the right by the predetermined threshold value (for example, 45 degrees) (NO) or more, the process advances to step S209.

(Step S207) The control unit 18 changes the layout based on the current layout determined in step S201. For example, when the current layout is the layout A1, the control unit 18 changes the current layout to the layout B1. When the current layout is the layout A2, the control unit 18 changes the current layout to the layout B2. When the current layout is the layout B1, the control unit 18 changes the current layout to the layout D1. When the current layout is the layout B2, the control unit 18 changes the current layout to the layout D2. When the current layout is the layout C1, the control unit 18 changes the current layout to the layout A1. When the current layout is the layout C2, the control unit 18 changes the current layout to the layout A2. When the current layout is the layout D1, the control unit 18 changes the current layout to the layout C1. When the current layout is the layout D2, the control unit 18 changes the current layout to the layout C2. Then, the process returns to step S201.

(Step S209) The control unit 18 determines whether the display screen has been rotated to the left by the predetermined threshold value (for example, 45 degrees) or more. When the control unit 18 determines that the display screen has been rotated to the left by the predetermined threshold value (for example, 45 degrees) or more (YES), the process advances to step S211. On the other hand, when the control unit 18 determines that the display screen has not been rotated to the left by the predetermined threshold value (for example, 45 degrees) (NO) or more, the process returns to step S203 without changing the layout.

(Step S211) The control unit 18 changes the layout based on the current layout determined in step S201. For example, when the current layout is the layout A1, the control unit 18 changes current layout to the layout C1. When the current layout is the layout A2, the control unit 18 changes the current layout to the layout C2. When the current layout is the layout B1, the control unit 18 changes the current layout to the layout A1. When the current layout is the layout B2, the control unit 18 changes the current layout to the layout A2. When the current layout is the layout C1, the control unit 18 changes the current layout to the layout D1. When the current layout is the layout C2, the control unit 18 changes the current layout to the layout D2. When the current layout is the layout D1, the control unit 18 changes the current layout to the layout B1. When the current layout is the layout D2, the control unit 18 changes the current layout to the layout B2. Then, the process returns to step S201.

### Summary of Embodiments

As described above, the information processing apparatus 10 according to one or more embodiments is capable of controlling display by splitting the screen of the display 150 (an example of a display) into two or more display areas, and includes the storage unit 13 (an example of a memory) that stores a program of an application, and the control unit 18 (for example, a processor such as a CPU, a GPU, or a microcomputer) that controls displaying a window of the application on the screen of the display 150 by executing the program of the application stored in the storage unit 13. The control unit 18 performs display layout control processing of controlling a layout in which arrangement of display areas is determined when the screen of the display 150 is split into the two or more display areas to a layout for “Portrait (or Clamshell)” (an example of the first layout) or a layout for “Landscape” (an example of the second layout) depending on the display orientation of the screen of the display 150. Each of the layout for “Portrait (or Clamshell)” and the layout for “Landscape” includes two layouts in which the arrangement of the display areas when one layout is rotated 180 degrees around an axis perpendicular to the screen of the display 150 corresponds to the arrangement of the display areas of the other layout (for example, the layout indicated by the reference numeral R13 and the layout by the reference numeral R14 in FIGS. 5A-5B, and the layout by the reference numeral R23 and the layout by the reference numeral R24). For example, when the display 150 is rotated 90 degrees around an axis perpendicular to the screen, the above two layouts included in the layout for “Portrait (or Clamshell)” (for example, the layout indicated by the reference numeral R13 and the layout indicated by the reference numeral R14 in FIGS. 5A-5B) corresponds to the arrangement of the display areas of one or the other of the two layouts mentioned above included in the layout for “Landscape” (for example, the layout by the reference numeral R23 and the layout by the reference numeral R24 in FIGS. 5A-5B).

As a result, when using the screen split into two or more display areas, since the information processing apparatus 10 supports layouts corresponding to each orientation so that the physical display positions can be matched in each orientation when the orientation of the display 150 changes (rotates), it is possible to control appropriately according to a change in the orientation of the display. For example, in the information processing apparatus 10, even if the orientation of the screen of the display 150 changes, the display orientation can be changed while maintaining the physical display position of each display area, the user can easily track the displayed windows with his or her eyes and can appropriately control the display.

For example, in the display layout control processing, the control unit 18 controls the layout for “Portrait (or Clamshell)” when the display orientation of the screen of the display 150 is such that the direction of the axis in the long side direction is the up-down direction of the display among the axis along the long side of the screen (an example of the first axis) and the axis along the short side of the screen (an example of the second axis) that are horizontal to the screen of the display 150 and orthogonal to each other through the center of the screen, and controls the layout for “Landscape” when the display orientation of the screen of the display 150 is such that the direction of the axis in the short side direction is the up-down direction of the display.

As a result, whether the long side direction of the screen of the display 150 is the up-down direction of the display or the short side direction of the screen is the up-down direction of the display, the information processing apparatus 10 can control display with a layout suitable for each orientation.

For example, the display orientation of the screen of the display 150 is such that the horizontal dimension of the screen is shorter than the vertical dimension (“Portrait (or Clamshell)”), or the horizontal dimension of the screen is longer than the vertical dimension (“Landscape”).

As a result, whether the orientation of the display 150 is such that the horizontal dimension of the screen is shorter than the vertical dimension or the horizontal dimension of the screen is longer than the vertical dimension, the information processing apparatus 10 can control display with a layout suitable for each orientation.

In addition, for example, when the layout for “Portrait (or Clamshell)” and the layout for “Landscape” are layouts in which the screen of the display 150 is split into three-part display areas, the following layouts are included. The layout for “Portrait (or Clamshell)” includes a layout in which the screen of the display 150 is split horizontally into a first display area and a second display area along an axis in the short side direction of the screen, and the first display area is split into two display areas (for example, the layout indicated by the reference numeral R14 in FIGS. 5A-5B), and a layout in which the screen of the display 150 is split horizontally into the first display area DA1 and the second display area along an axis in the short side direction of the screen, and the second display area is split into two display areas (for example, the layout indicated by the reference numeral R13 in FIGS. 5A-5B). The layout for “Landscape” includes a layout in which the screen of the display 150 is split horizontally into a third display area and a fourth display area along an axis in the long side direction and the third display area is split into two display areas (for example, the layout indicated by the reference numeral R24 in FIGS. 5A-5B), and a layout in which the screen of the display 150 is horizontally split into a third display area and a fourth display area along the axis in the long side direction and the fourth display area is split into two display areas (for example, the layout indicated by the reference numeral R23 in FIGS. 5A-5B).

As a result, when using the screen split into three display areas, since the information processing apparatus 10 supports layouts corresponding to each orientation so that the physical display positions of the three display areas can be matched in each orientation when the orientation of the display 150 changes (rotates), it is possible to control appropriately according to a change in the orientation of the display.

In addition, the control unit 18 changes the display orientation while maintaining the display position (arrangement) of the window displayed in each of the two or more display areas according to a change in the orientation of the screen of display 150.

As a result, even if the orientation of the screen of the display 150 changes, since the information processing apparatus 10 can change the display orientation while maintaining the physical display positions of the windows displayed in the three-part layout, the user can easily track the displayed windows with his or her eyes and control the display appropriately.

In addition, the control unit 18 displays the layout selection icon L1 or L2 from which a display area is selectable, in which the window is to be displayed from among a layout for “Portrait (or Clamshell)” or a layout included in a layout for “Portrait (or Clamshell)” due to accepting the drag operation on the window displayed on the screen of the display 150. Then, the control unit 18 selects the display area selected by the drag operation on the layout selection icon L1 or L2 as a display area for displaying the window being dragged, and displays the window in the selected display area in response to completion of the drag operation on the window.

As a result, the information processing apparatus 10 can easily arrange (snap) the window in a desired display area based on an operation of dragging the window, regardless of the orientation of the screen of the display 150. In addition, the information processing apparatus 10 can maintain the display position of the window snapped by the user even if the orientation of the screen of the display 150 is changed (rotated).

No matter which orientation of the screen of the display 150 is changed (rotated) to, the information processing apparatus 10 may restore the size of the display area at the snap destination to the original size before the snap by canceling the snap of the snapped window (for example, starting the drag operation again).

In addition, the information processing apparatus 10 can snap another window by dragging the window over the display area while maintaining the display position (display area) of the snapped window, or can snap the window to another display area.

In addition, a control method in the information processing apparatus 10 according to one or more embodiments that is capable of controlling display by splitting the screen of the display 150 (an example of a display) into two or more display areas, including the storage unit 13 (an example of a memory) that stores a program of an application, and the control unit 18 (an example of a processor such as CPU, GPU, microcomputer) that controls displaying a window of the application on the screen of the display 150 by executing the program of the application stored in the storage unit 13, the control method including: via the control unit 18, a determination step of determining display orientation of the screen of the display 150, and a display layout control step of controlling a layout in which arrangement of display areas is determined when the screen of the display 150 is split into the plurality of display areas to a layout for “Portrait (or Clamshell)” (an example of the first layout) or a layout for “Landscape” (an example of the second layout) depending on the display orientation of the screen of the display 150 determined in the determination step. Then, each of the layout for “Portrait (or Clamshell)” and the layout for “Landscape” includes two layouts in which the arrangement of the display areas when one layout is rotated 180 degrees around an axis perpendicular to the screen of the display 150 corresponds to the arrangement of the display areas of the other layout (for example, the layout indicated by the reference numeral R13 and the layout by the reference numeral R14 in FIGS. 5A-5B, and the layout by the reference numeral R23 and the layout by the reference numeral R24). For example, when the display 150 is rotated 90 degrees around an axis perpendicular to the screen, the above two layouts included in the layout for “Portrait (or Clamshell)” (for example, the layout indicated by the reference numeral R13 and the layout indicated by the reference numeral R14 in FIGS. 5A-5B) corresponds to the arrangement of the display areas of one or the other of the two layouts mentioned above included in the layout for “Landscape” (for example, the layout by the reference numeral R23 and the layout by the reference numeral R24 in FIGS. 5A-5B).

As a result, with the control method in the information processing apparatus 10, when using the screen split into two or more display areas, since the information processing apparatus 10 supports layouts corresponding to each orientation so that the physical display positions can be matched in each orientation when the orientation of the display 150 changes (rotates), it is possible to control appropriately according to a change in the orientation of the display. For example, with the control method in the information processing apparatus 10, even if the orientation of the screen of the display 150 changes, the display orientation can be changed while maintaining the physical display position of each display area, the user can easily track the displayed window with his or her eyes and can appropriately control the display. In addition, with the control method in the information processing apparatus 10, it is possible to maintain the display position of the window snapped by the user even if the orientation of the screen of the display 150 is changed (rotated).

Although the embodiments of the present invention have been described above in detail with reference to the accompanying drawings, a specific configuration is not limited to the above-described configuration, and various design changes and the like can be made without departing from the gist of the present invention. For example, the configurations described in the above-described embodiments may be optionally combined.

In one or more embodiments, a control is performed to change the display orientation while maintaining the physical display position of each display area according to a change in the orientation of the screen (rotation), but although each of the above layouts is used in the same way, the information processing apparatus 10 may change the display orientation without maintaining the physical display position of each display area according to a change in the orientation of the screen (rotation) (for example, by determining the display position according to preset display position rules for each layout).

In addition, in the information processing apparatus 10 according to one or more embodiments described above, one foldable display 150 is provided extending from the inner surface of the first chassis 101 to the inner surface of the second chassis 102, but the present invention is not limited thereto. For example, the information processing apparatus 10 may be configured to include a display only on the inner surface of the first chassis 101. In addition, the information processing apparatus 10 may be configured to include a display on each of the inner surface of the first chassis 101 and the inner surface of the second chassis 102.

In addition, in one or more embodiments described above, the display (screen area) whose display is controlled by the information processing apparatus 10 may be an embedded display of the information processing apparatus 10, may be the external display of the external display device 20, or may be both. For example, when the information processing apparatus 10 is connected to the external display device 20, and when the external display (display 250) of the external display device 20 supports screen rotation, the display layout change processing for the display 150 can be similarly applied to the display 250, and the same effects described above can be obtained.

In addition, when the information processing apparatus 10 is equipped with a plurality of embedded displays, the plurality of embedded displays may be the targets of the display layout change processing. In addition, when the information processing apparatus 10 is connected to a plurality of external display devices 20, a plurality of external displays may be the targets of the display layout change processing, or a plurality of external displays and one or more embedded displays may be the targets of the display layout change processing. That is, the plurality of displays (screen areas) whose display is controlled by the information processing apparatus 10 may be one display (screen area), may be may be two displays (screen areas), or may be three or more displays (screen areas), and these displays (screen areas) may be either embedded displays or external displays.

In addition, in one or more embodiments described above, there are three types of layouts that can be selected from the layout selection icon L1 or L2 (see FIGS. 5A-5B): a layout in which the entire screen area of the display 150 is one display area, a layout in which the screen area is split into two, upper and lower, and a layout in which the screen area is split into three, but the present invention is not limited thereto. For example, it may be possible to select only a part of the above three types of layouts, or it may be possible to select a layout in which the screen area is split into four or more display areas.

In addition, in one or more embodiments described above, in the display layout control processing in a three-part layout, although the control for changing the display orientation while maintaining the physical display position of each display area according to a change (rotation) in the orientation of the screen has been described, the present invention is not limited thereto. Similarly, when using a two-part layout or a four or more-part layout, in the display layout control processing, the information processing apparatus 10 may apply control for changing the display orientation while maintaining the physical display position of each display area according to a change (rotation) in the orientation of the screen.

In addition, the layout when splitting the screen area into two or more display areas can be a layout in which the screen area is split into arbitrary display areas. For example, the three-part layout is not limited to the layouts illustrated in FIGS. 5A to 7, and the like, and may be a layout split into three display areas in the vertical or horizontal direction.

Further, in one or more embodiments described above, an example of touch operation on a plurality of touch panel displays that are configured by integrating an input unit (touch sensor) and a display unit is described, but the present invention is not limited to the touch panel display.

The information processing apparatus 10 described above has a computer system inside. The process in each configuration of the information processing apparatus 10 described above may be performed by recording a program for realizing the function of each configuration of the information processing apparatus 10 described above on a computer-readable recording medium, and reading the program recorded on the recording medium with the computer system to execute the program. Here, “reading the program recorded on the recording medium into the computer system to execute the program” includes installing the program in the computer system. The “computer system” herein includes the OS or hardware such as peripheral devices. In addition, the “computer system” may include a plurality of computer apparatuses connected via a network including a communication line such as the Internet, a WAN, a LAN, or a dedicated line. In addition, the “computer-readable recording medium” is a portable medium such as a flexible disk, a magneto-optical disk, a ROM, or a CD-ROM, and a storage device such as a hard disk built in the computer system. As described above, the recording medium that stores the program may be a non-transitory recording medium such as a CD-ROM.

In addition, the recording medium also includes an internal or external recording medium that can be accessed from a distribution server to distribute the program. A configuration may be used in which the program is divided into a plurality of programs, downloaded at different timings, and then combined with each configuration of the information processing apparatus 10, or distribution servers for distributing the respective divided programs may be different. Further, the “computer-readable recording medium” includes a medium, which holds the program for a certain period of time, such as a volatile memory (RAM) inside the computer system that serves as a server or a client in a case in which the program is transmitted via the network. The above-described program may be a program for realizing a part of the above-described functions. Further, the program may be a so-called difference file (difference program) in which the above-described functions can be realized in combination with the program already recorded in the computer system.

A part or all of the functions of the information processing apparatus 10 in the above-described embodiments may be realized by an integrated circuit such as a large scale integration (LSI). Each of the functions may be individually realized as a processor, and a part or all of the functions may be integrated into a processor. A method of achieving the integrated circuit is not limited to the LSI, and may be realized by a dedicated circuit or a general-purpose processor. In a case in which advances in a semiconductor technique lead to appearance of an integrated circuit technique that replaces the LSI, an integrated circuit based on the technique may be used.

### DESCRIPTION OF SYMBOLS

10 information processing apparatus
101 first chassis
102 second chassis
103 hinge mechanism
11 communication unit
12 RAM
13 storage unit
14 speaker
15 display unit
16 camera
150 display
155 touch sensor
161 first acceleration sensor
162 second acceleration sensor
17 hall sensor
18 control unit
19 external connection terminal
180 state determination unit
181 display selection icon display processing unit
182 display selection processing unit
183 layout selection icon display processing unit
184 layout selection processing unit
185 display layout control unit

1. An information processing apparatus that is capable of controlling display by splitting a screen of a display into two or more display areas, the apparatus comprising:
a memory configured to store a program of an application; and
a processor configured to control displaying a window of the application on the screen of the display by executing the program of the application stored in the memory, wherein when the screen of the display is split into the two or more display areas:
the processor is configured to perform display layout control processing that controls an arrangement of the display areas depending on an orientation of the display according to a first layout and a second layout,
wherein each of the first layout and the second layout includes a first arrangement and a second arrangement,
wherein when the display is rotated 180 degrees around an axis perpendicular to the screen of the display, the display layout control processing changes from the first arrangement to the second arrangement of the first layout, and
when the display is rotated 90 degrees around the axis perpendicular to the screen of the display, the display layout control processing changes from the first layout to the second layout,
wherein, in response to connecting an external display device to the information processing apparatus, the processor is further configured to:
display icons to the display and the external display device, determine a selected display area based on a drag operation of the window onto one of the icons, and
display the window in the selected display area in response to completion of the drag operation of the window, wherein the window is to be displayed from among the arrangements included in the first layout or the second layout.

2. The information processing apparatus according to claim 1, wherein
the processor is configured to, in the display layout control processing, when the display orientation of the screen of the display is such that a direction of a first axis is an up-down direction of display among the first axis and a second axis that are horizontal to the screen of the display and orthogonal to each other through a center of the screen, control the display according to the first layout, and when the display orientation of the screen of the display is such that a direction of the second axis is the up-down direction of the display, control the display according to the second layout.

3. The information processing apparatus according to claim 1, wherein
the display orientation of the screen of the display is such that a horizontal dimension of the screen is shorter than a vertical dimension of the screen, or the horizontal dimension of the screen is longer than the vertical dimension of the screen.

4. The information processing apparatus according to claim 2, wherein
when the first layout and the second layout are layouts in which the screen of the display is split into three display areas,
the first arrangement of the first layout splits the screen of the display horizontally into a first display area and a second display area along the second axis and the first display area is split into two display areas, and the second arrangement of the first layout splits the screen of the display horizontally into the first display area and the second display area along the second axis and the second display area is split into two display areas, and
the first arrangement of the second layout splits the screen of the display horizontally into a third display area and a fourth display area along the first axis and the third display area is split into two display areas, and the second arrangement of the second layout in which the splits the screen of the display horizontally into the third display area and the fourth display area along the first axis and the fourth display area is split into two display areas.

5. The information processing apparatus according to claim 1, wherein
the processor is configured to change the display orientation while maintaining arrangement of the window displayed in each of the two or more display areas in response to a change in orientation of the screen of the display.

6. (canceled)

7. A control method in an information processing apparatus that is capable of controlling display by splitting a screen of a display into two or more display areas, and that includes a memory configured to store a program of an application, and a processor configured to control displaying a window of the application on the screen of the display by executing the program of the application stored in the memory,
the control method comprising:
via the processor,
a determination step of determining display orientation of the screen of the display; and
a display layout control step of controlling a layout, according to a first layout and a second layout, in which arrangement of the display areas is determined when the screen of the display is split into the two or more display areas to a first layout or a second depending on the display orientation of the display determined in the determination step, wherein
each of the first layout and the second layout includes two layouts a first arrangement and a second arrangement,
wherein when display is rotated 180 degrees around an axis perpendicular to the screen of the display, the display layout control changes the first arrangement to the second arrangement of the first layout, and
when the display is rotated 90 degrees around the axis perpendicular to the screen of the display, the display layout control changes the first layout to the second layout,
wherein, in response to connecting an external display device to the information processing apparatus, the control method further includes:
displaying icons to the display and the external display device,
determining a selected display area based on a drag operation of the window onto one of the icons, and
displaying the window in the selected display area in response to completion of the drag operation of the window, wherein the window is to be displayed from among the arrangements included in the first layout or the second layout.
